(19) United States
(12) Patent Application Publication
(10) Pub. No.: US 2018/0218436 A1
(43) Pub. Date: Aug. 2, 2018

(54) Virtual Personal Shopping System

(71) Applicant: Chaya Cooper, New York City, NY (US)

(72) Inventor: Chaya Cooper, New York City, NY (US)

(21) Appl. No.: 15/883,037

(22) Filed: Jan. 29, 2018

Related U.S. Application Data
(63) Continuation of application No. 13/897,357, filed on May 18, 2013, now abandoned.

(51) Int. Cl. G06Q 30/06

(52) U.S. Cl. CPC G06Q 30/0631

(57) ABSTRACT

The invention relates to selecting products and/or services that meet a customer's needs. In particular, the invention relates to an automated method and system for recommending relevant products and/or services utilizing expert knowledge.

This application is a continuation of U.S. patent application Ser. No. 13/897,357, filed on May 18, 2013, which is incorporated herein by reference in its entirety.

### FIELD OF THE INVENTION

The invention relates to selecting products and/or services that meet a customer's needs. In particular, the invention relates to an automated method and system for recommending relevant products and/or services.

### BACKGROUND AND PROBLEM

### Problems Faced by Retailers and Consumers

Retailers lack sufficient information to know which products their customers want and lack adequate tools to recommend relevant products. As a result, shoppers are faced with a vast number of mostly irrelevant products, and retailers are required to rely far too heavily upon customers working hard to find products, marking down between 30-50% of products, and losing a significant number of sales.

More than half the time, consumers are looking for something specific when they shop for clothing, yet only a small number successfully complete a purchase during a visit (20-25% in-store and 2-3.5% online). The primary cause for these low conversion rates is that the overwhelming majority of consumers have difficulty finding clothing that meets their specific needs.

Over 90% of consumers consider, in descending order of importance, looks good on them, fits, and easy care as being both very important to them and their primary purchase requirements. Preferred characteristics—important but not primary to their purchase decision—are taste, and additional lifestyle factors such as price, fabric content and lifestyle appropriate. While shoppers are only interested in products that meet these criteria, there is no efficient or accurate method—online or off—for identifying those few products. Consumers must sift through hundreds, if not thousands, of products to identify the few items that meet their specific criteria, manually assessing each item by looking at it, reading the hangtags and labels, and trying it on. In order to narrow their search, shoppers often rely upon surrogates such as brands or generalized product categories, but these filters still include a significant percentage of irrelevant products and omit many relevant ones. It can be even more challenging to identify relevant products online as qualitative criteria such as flatter, fit and style are far more difficult to determine remotely, and while search technology does make it easier to identify products matching quantitative criteria such as price, fabric, color and size, it takes far more time to browse online than to visually scan the items in-store. In addition, most retailers fail to provide sufficient, knowledgeable or effective salespeople. Moreover, even the best salesperson or personal shopper can only provide educated guesses due to human limitations and the complex nature of making clothing recommendations. While there are significant limitations to the services provided by salespeople, they are still the primary means available for guiding customers to relevant products, and online retailers attempt to replicate some of those benefits with product recommendation technology.

Flatter and fit are the most important characteristics in determining whether consumers will buy a garment, however these are the areas in which customers experience the greatest difficulty. In fact, 85% of consumers buy a specific brand because of the way it fits his or her figure (flatter+fit), and the greatest concern for consumers about purchasing apparel online is that ‘it will not look good on them or fit them’. However, while these are the most important criteria for almost all consumers, the majority have trouble finding clothing that flatters or fits, and women consider ‘finding styles that look good on them’ to be the most challenging part of shopping for clothing. The primary cause of these difficulties is that designers are required to select one body shape when mass-manufacturing clothing, but clothing designed for one body shape will never fit or flatter other shapes. As a result, most clothing only fits or looks good on a small percentage of consumers. A secondary issue within fit is significant inconsistencies between, or even within, brands, which creates additional difficulties both online and off-line, and is a significant contributor to the high rate of online apparel returns.

While the gap between consumers' needs and the products available is most noticeable with regards to flatter and fit, retailers and manufacturers have lacked the necessary tools to determine customers' preferences and needs in most areas. Retailers have therefore been limited to analyzing past sales, however apparel has multiple qualitative features, and assumptions based upon past sales can be very misleading without understanding which features led to a purchase. Most retailers do not define SKU's (stock-keeping units) by their attributes, and the key for retailers being able to do more than guess at the demand for a specific SKU is to understand the demand for specific attributes.

Limitations of Existing Technology

Expert systems integrate explicit subject-matter knowledge into computer systems in order to solve problems normally requiring a high level of human expertise. Expert systems are generally used to facilitate tasks in fields such as financial services, law, manufacturing and medicine, which require a substantial knowledge base in order to solve problems, but where the relevant human reasoning and logic is fairly straightforward. Artificial Intelligence (AI) researchers have been able to create computers that can perform jobs that are complicated for people to do—typically due to processing speed or memory constraints of the human brain—but these tasks are typically ones which have a well-established conscious, step-by-step deduction process; and they have struggled to develop a computer that is capable of carrying out many cognitive tasks, including ones which are very simple for humans to do.

This has been attributed to our limited understanding of the brain's neurophysiology and cognitive functions, as well as AI's difficulty dealing with Commonsense Knowledge. In contrast to expert knowledge, which is usually explicit, most Commonsense Knowledge is implicit. Much of what people know is not represented as “facts” or “statements” that they could express verbally (For example, an art critic can take one look at a statue and instantly realize that it is a fake, but would be hard-pressed to verbalize much of the reasoning process which led them to that conclusion). These are intuitions or tendencies that are represented in the brain non-consciously and sub-symbolically. Knowledge like this informs, supports and provides a context for symbolic, conscious knowledge, and AI has yet to develop methods for performing even the most simple Commonsense Reasoning.

Recommending personally relevant products is substantially more challenging than the problem solving typically done by expert systems because the logic and decision-making which experts apply to assess customers and products and make recommendations is far more complex, and much of it is made non-consciously and sub-symbolically. As a result of the aforementioned difficulties AI has in performing these tasks, most technologies utilize other methods for generating personalized recommendations, the most popular of which is Collaborative Filtering (used by companies including Amazon, iTunes, and Netflix)—which needs no built-in expertise or subject knowledge (of either customers or products) to generate recommendations.

Apparel recommendations are significantly more complex than other product categories because there are substantially more attributes to consider, as well as a far greater number of key criteria and types of variables. In addition, while there are a great number of expert rules in the public domain which are used by stylists to recommend product and/or product combinations, a large percentage of the reasoning and decision-making is done non-consciously and sub-symbolically, and the rules governing those processes have not been compiled or even articulated. Moreover, apparel recommendations are typically considered more of an art than a science—relying to a great extent on an expert's natural talent, sense of style and intuition—and have therefore been considered to be beyond the capability of existing methods and technologies. Furthermore, even though many of the rules are well-known, they have proven to be too numerous and fragmented for companies to successfully develop accurate recommendation technology using existing methodologies.

There are no accurate and scalable solutions for recommending clothing that flatter, fit and/or match taste or lifestyle needs; and none considers all of the key decision making factors. In addition, there aren't any accurate or comprehensive cross-selling and targeted marketing solutions for apparel. Finally, existing apparel recommendation technologies do not obtain and/or utilize an accurate and comprehensive understanding of the customer's attributes, needs and preferences, and there are no scalable solutions that develop an accurate and comprehensive understanding of the products' attributes.

### SUMMARY OF THE INVENTION

This invention, which runs over computer networks, such as shown in FIG. 2, allows companies to show every customer the few products and/or services which are just right for them, both online and in-store, and significantly increases sales, profit margins and customer loyalty. Our automated and scalable recommendation technology utilizes a proprietary methodology, algorithms and logic (as outlined in the Detailed Description of the Invention), and expert rules to accurately select products and/or services that objectively and subjectively meet that specific customer's needs. Customers may be given detailed feedback explaining a product's pros and cons as it relates to their profile. Customer data may also be used to automatically cross-sell all appropriate products and/or services and for targeted marketing campaigns, and may be reported in aggregate to retailers, manufacturers and service providers for planning purposes.

Our methodology utilizes logic and thousands of expert rules, to assess products' attributes as well as the customer's specific attributes, needs and preferences, and match specific key product attributes to each individual customer's detailed information, preferences, taste and lifestyle. In addition, our algorithms assess how the customer's various attributes and needs interact, and handles contradictions based on both objective criteria and subjective weights assigned by the customer.

In addition, we have resolved the primary barrier to developing expert recommendations systems by designing a novel method for creating expert rules. We have identified the core expert rules and scientific principles that form the basis of the conscious and unconscious expert assessment and decision-making process, and designed a unique and intuitive process for acquiring both the explicit and implicit expert knowledge in the Expert Rules Interface. In addition, we have identified a core group of human and product attributes (i.e. color, fabric content, fabric properties, etc.) which they all use, and were therefore able to automate much of the process for creating the relevant rules, and significantly simplify creating the remaining rules.

This invention is being described in terms of the fashion industry, but it could very well be applied to other consumer and business products and services in order to easily identify items which are most likely to meet customers' criteria. Similarly, much of it is described in relation to retailers, but its use is not limited to retailers and the invention may be used to recommend products and/or services in other environments as well.

### Our Solution

Our technology enables retailers to quickly and accurately recommend personally relevant clothing, accessories and shoes to each customer by identifying products that will objectively and subjectively fit and flatter the customer, meet their taste, personal style, preferences and lifestyle needs, and may provide expert feedback explaining why an item is or is not being recommended. It allows retailers to show customers only those products which are personally relevant while browsing or searching on their website, or mobile and in-store applications, as well as to customize their online and offline advertising and marketing campaigns.

To the consumer, this technology serves as a virtual personal shopper or expert stylist, offering an easier, more convenient, and less time-consuming means to shop for apparel across all channels. Furthermore, it almost completely eliminates the perceived dilemma consumers associate with purchasing clothing online, and brings much of the convenience associated with shopping online into the traditional retail environment. This technology appeals equally to men and women and provides a service that most consumers want—whether it's because they don't have time, don't like to shop, have a hard time finding clothing, or just want a little more help than salespeople usually provide.

Recommending personally relevant clothing requires an accurate and comprehensive understanding of both the customer and the products, as well as an accurate methodology for matching the two. Our technology is the only one which develops an accurate and comprehensive understanding of the customer's attributes, needs and preferences, and is the only scalable solution that develops an accurate and comprehensive understanding of the products' attributes. We utilize that information to match customers to personally relevant items based on specific product attributes; making this the first true preference engine.

Our technology is the only one which considers customer's criteria in all four key areas—flatter, fit, taste or lifestyle needs, and it is the only accurate and scalable solution for recommending clothing in any of those categories.

Taste and Specific Style Preferences—To determine which specific styles a customer will like, one must have an understanding of their fashion sensibility, or taste, as well as their preferences/aversions for specific features or details. A garment's specific taste category is an amalgam of several attributes: its overall style or silhouette, specific design features (i.e. specific neckline or sleeve type), color, and fabric print. In addition to determining taste, these attributes are also the key to knowing which specific styles a customer will like, as evidenced by the fact that while most designers successfully convey a consistent fashion sensibility throughout their designs, customers will like some styles and not others due to its specific attributes. Our technology is the only search or recommendation technology that accurately selects clothing matching a customer's taste or specific style preferences, and the only solution capable of assessing all appropriate products and recommending only relevant items. It determines a customer's overall fashion sensibility, as well as preferences or aversions for specific styles, design features, colors and fabric prints, and is the only technology to form an accurate or comprehensive understanding of a customer's taste. In addition, it is the first technology to provide a scalable method for accurately determining a product's detailed taste category.

Flatter Determination & Selection—For clothing to look good on a customer it must flatter their body shape and proportions, individual features, specific problem areas, and coloring based upon both expert rules and the customer's feelings about their best and worst attributes, the features they like to highlight, and the attributes they prefer minimizing or enhancing. Accurately determining the items which will flatter a customer requires analyzing these factors as well as the product's silhouette, styling details and specific placement of those details, color and placement of color, and texture and drape of fabric. Our technology is the only one to offer an automated or scalable ‘flatter’ solution, and is the only technology which accurately addresses the entire range of customer and product issues that affect a garments flatter factor. In addition, it is the only technology that provides individualized expert feedback to shoppers explaining why a garment will/will not flatter them, and the only one which integrates into a retailer's website and in-store applications.

Fit Determination & Selection—Accurately determining a garment's fit requires analyzing the customer's measurements, fit preferences, and usage of modifying garments, as well as the product's measurements (specs), design intent (slim vs. boxy cut), and fabric properties (including range of movement). Our technology provides the only solution that accurately selects garments that will fit a customer's measurements and fit preferences. In addition, our technology is the only one that provides a comprehensive but user-friendly description of the pros & cons of a garment's fit. It can run in parallel with existing fit analysis and size prediction technology.

Personal Preferences & Lifestyle—For products to be personally relevant they must also match a customer's personal preferences regarding price, color, and fabric content, properties (i.e. stretch, wrinkle resistance and seasonless), and care. In addition, the style must be one that the customer will have occasion to wear based on their lifestyle, style/s of dress for daytime and evening, and their preferences regarding multi-purpose, seasonless or seasonal clothing. Our technology is the only search or recommendation technology that accurately selects clothing matching a customer's personal preferences or lifestyle needs.

Cross-Selling—Effective cross-selling increases basket size by recommending additional items that complement an item being purchased and that are personally relevant, however it is far more complex with apparel than most categories. Effectively cross-selling apparel requires sophisticated rules regarding color, fashion and proportions in order to not only accurately recommend items that meet all of the aforementioned customer criteria, but to also determine which items look good together and combine properly to create an outfit, and that a customer will look good in and like, both individually and combined. In addition, for outfits to be personally relevant it is important to consider the type of accessories a customer wears and the degree to which a customer accessorizes. Our technology offers the only taste, flatter or fit recommendation engine utilizes its technology to combine items for purposes of cross-selling personally relevant outfits, and offers the only cross-selling technology that accurately recommends personally relevant and appropriate apparel and accessories to complement a product.

### BRIEF DESCRIPTION OF THE DRAWINGS

FIG. 1

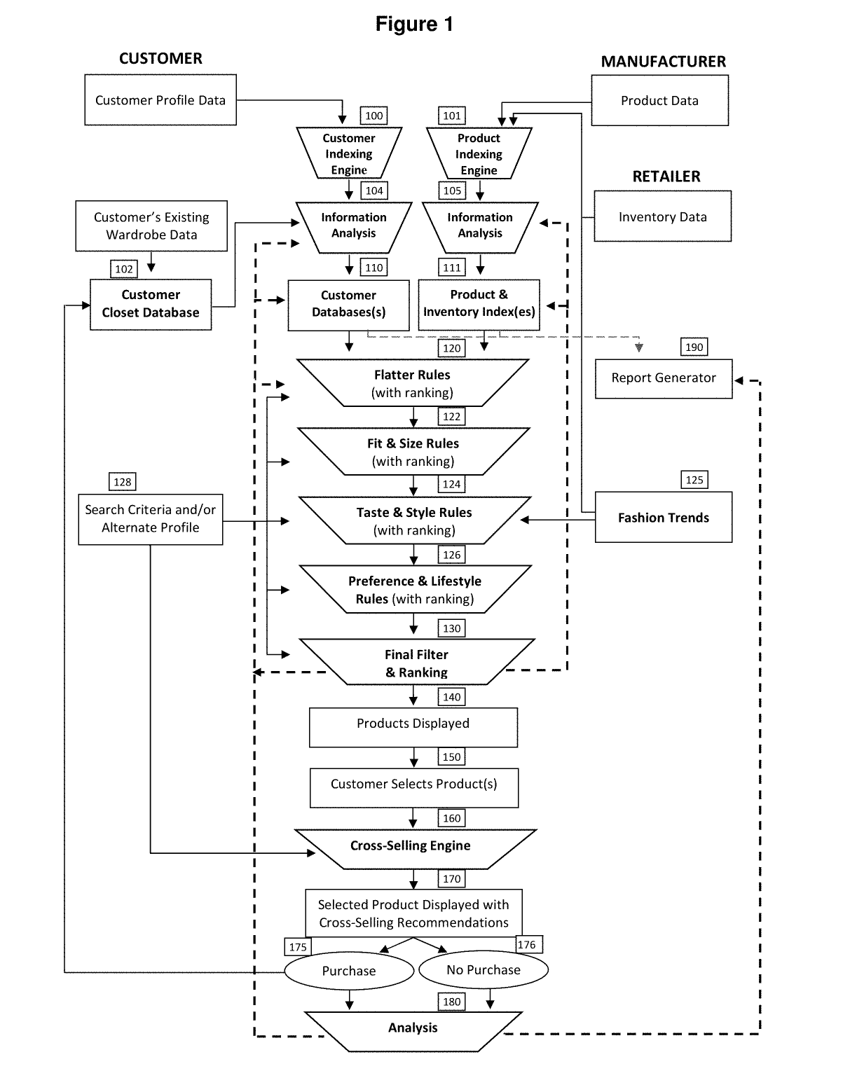

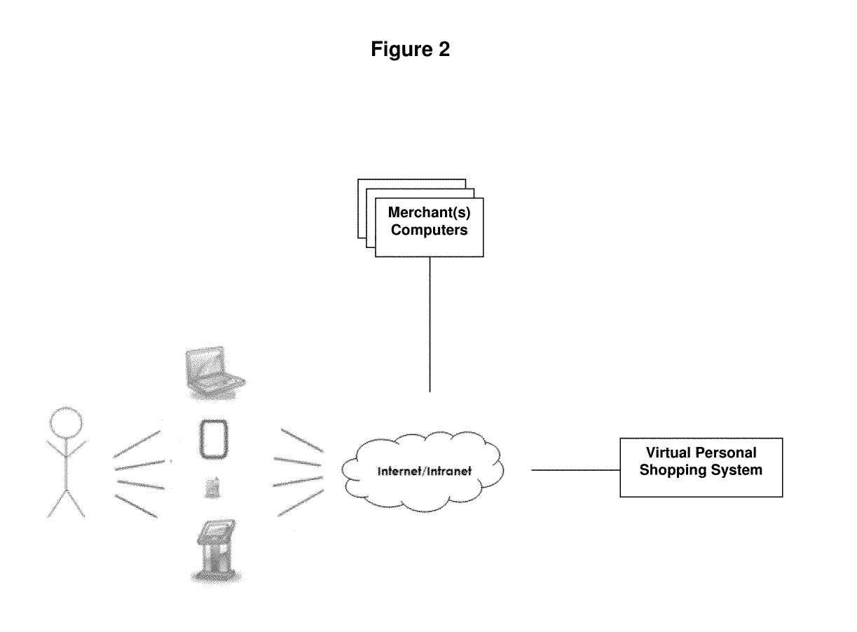

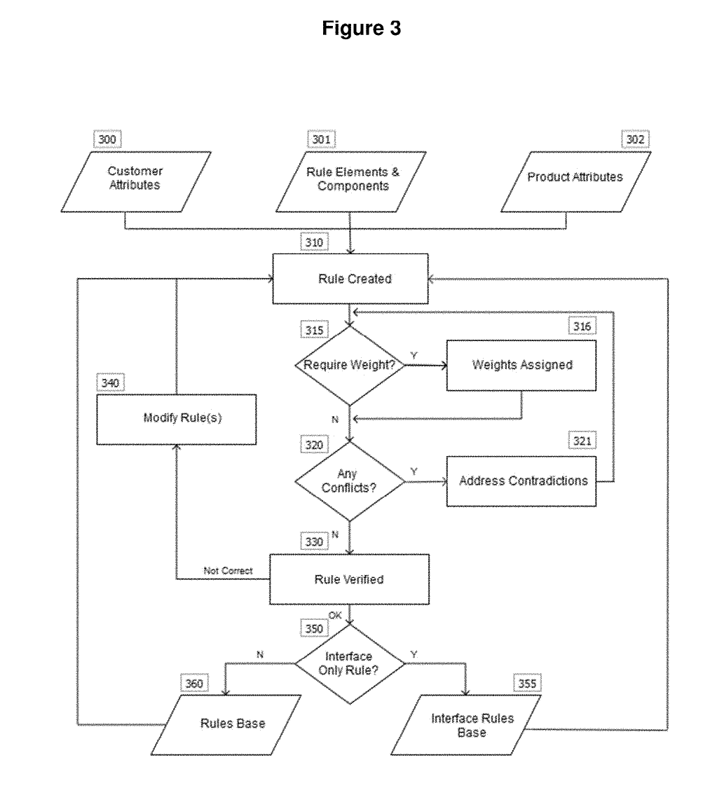

According to one embodiment of the invention, information is used from the customer, manufacturer and retailer in the manner described in FIG. 1 to offer targeted merchandise to the customer.

Customer Profile Data, which the customer has input as described below, is distilled and categorized (by the Customer Indexing Engine 100), and may be analyzed (by the Inference Engine at step 104) before being placed into the Customer Database(s) (110). Step 104 may also incorporate the analysis performed at step 180. In addition, information from the Customer Closet Database (102), which is a collection of items from the customer's existing wardrobe and purchases from the web site, may also be added to the Customer Database (110). Product Data from the manufacturer and Inventory Data from the retailer is distilled, categorized and processed (by the Product Indexing Engine 101) and may be analyzed (by the Inference Engine at step 105), before being placed into the Product & Inventory Index(es) (111). Product Indexing Engine (101) may also receive input from Fashion Trends (125). Expert rules and logic from the Rules Base are used at steps 100, 101, 104 and 105 by the Customer and Product Indexing Engines and/or the Inference Engine to complete the aforementioned tasks and to assign a vector (list of attributes) to each person and product.

Data from Customer Database (110) and Product & Inventory Index (111) is passed to one or more sets of Rule Categories in the Inference Engine (Flatter Rules 120, Fit Rules 122, Taste Rules 124, Preferences & Lifestyle Rules 126), or straight to the Combination Rules for the Final Filter & Ranking 130 in parallel or from one set of Rules to another (or any order combination). Each set of Rules takes the data fed to it and ranks items accordingly, as described above. The Inference Engine may also take into consideration Search and/or an Alternate Profile 128 that may have been previously input by the customer. Note that for different types of products, different sets of Rule Categories may be used. Data from the Final Filter & Ranking 130 may also be fed back into Customer Database 110 and/or Product & Inventory Index 111.

At step 140, the products determined by the Inference Engine to most closely fulfill the customer's immediate request are displayed to the customer. Parameters may be set to limit the number of products displayed if there are too many results and/or to display lower ranking products if there are too few results. In addition, the following may be displayed to the customer alongside the products: rating; recommended size and color; and expert feedback and pros and cons.

At step 150 the customer selects one or more of these products for which he or she wishes to view more information and possibly purchase. As the product displayed at step 140 may be a group of items, flow may go back to 140 from 150 to narrow the selection down from a group to an individual item. At step 160 the Inference Engine utilizes Cross-Selling Rules from the Combination Rules set to choose the best products for the customer to combine with the selected item based on the selected product 150, the customer's vector, any Search Criteria/Alternate Profile 128, product vectors and inventory data. Cross-selling can also be performed at step 140 when the products are displayed or later when the user is in the shopping cart.

At step 170, cross-selling recommendations may be displayed alongside the product selected by the customer. In addition, the following may be displayed to the customer alongside the products: rating; recommended size and color; and expert feedback and pros and cons. At this point the customer chooses to either purchase or not purchase the displayed items. Not purchasing an item at this point can mean that the customer has completed their session or that they are still browsing and may purchase the item at a later time. Items purchased are added to the Customer Closet Database 102.

After the customer makes his or her decision, the Inference Engine analyzes the information at step 180. Direct or indirect customer feedback may also be analyzed. This analysis is fed back into the system and may be used to provide better suggestions to the customer for subsequent items that the customer will view. The analysis from 180 is added to the Customer Database 110, and may also be used at steps 120, 122, 124, 126 and 130. In this manner, the system learns the customer's preferences and can adapt recommendations accordingly. The analysis from steps 100, 101, 104, 105 and 180 are also fed into a Report Generator 190, which sends merchandising information to either the retailer or the manufacturer or both.

Changes to a retailer's inventory (adding or removing items or SKU's) are reflected in 111, and recommendations are updated accordingly. Similarly, changes to a customer's profile are reflected in 110, and recommendations are updated accordingly.

FIG. 2

This invention, which runs over computer networks, such as shown in FIG. 2, allows companies to show every customer the few products and/or services which are just right for them, both online and in-store.

According to one embodiment of the invention, consumers may connect to the internet or a company's intranet via devices including computers, tablets, mobile devices, kiosks and point-of-sale technology. Recommendations may be available through other company's websites and applications, or through our own websites and applications.

FIG. 3

According to one embodiment of the invention, system rules may be created in the Expert Rules Interface, using some or all of the steps shown in FIG. 3. Steps may be performed in any order combination.

Rules may be constructed utilizing Customer Attributes (300), Product Attributes (302) and/or Rule Elements and Components (301). Rule Elements and Components may include: desired Objective and/or Goal (subset of Objective), Methods for achieving Objective or Goal (including Parent, Child and Grandchild Methods), Specific Examples or Applications of the Method, Core Rules; Application Rules which define how Core Rules are combined and applied to customers and products; Process Rules, which are used by other rules and define methods, relationships and connections; and Principles, which are the core expert rules and scientific principles used to form most rules. In addition, previously completed rules from 355 and 360 may also be utilized.

Information from 300, 301, 302, 355 and/or 360 are combined at step 310 to form rules. At 315 and 320 a determination is made whether a weight needs to be assigned and/or any conflicts or contradictions need to be addressed, and these are done at 316 and 321 respectively. Steps 315 and 320 can be performed in any order, and since any changes made at 316 and 321 may result in additional changes needing to be made, there may be a need to loop through each step more than once. Steps 310, 315, 316, 320 and 321 may be performed automatically by the system, manually, or a combination of the two.

At 330, rules are verified for accuracy and any necessary adjustments may be made (340) to the rule which was just created as well as any of the information it utilizes from 300, 301, 302, 355 and/or 360. If changes are made at 340, the process loops back to 315 and 320 to determine if weights need to be assigned or adjusted and/or if there are any conflicts or contradictions that need to be addressed.

Once verification is completed, rules are added to the Rules Base (360) and/or the Interface Rules Base (355).

### DETAILED DESCRIPTION OF THE INVENTION

The methodology includes the use of precisely defined terminology and a consistent frame of reference throughout, as well as the following components: One or more Ontology(ies) to render a shared vocabulary and taxonomy; The Expert Rules Interface which acquires the explicit and implicit expert knowledge and creates the rules for the Rules Base; The Rules Base which contains expresses the knowledge to be used by the system; The Indexing Engine and Inference Engine which use the rules to categorize input and generate expert recommendations. In addition, there are a few components which interact with the customers and/or retailers, including: The User Interface which obtains customer and product information and communicates with users; An Explanation Module to elucidate how conclusions were made; and the selling, merchandising and marketing tools described below.

The selection and recommendation process may include the following steps:
Obtain customer and product information
Combine customer and product information with specific search criteria. May also incorporate real-time inventory data
Categorize customers and products by applying expert and logic rules
Assign weights and resolve conflicts based on expert weighing guidelines and the customer's priorities
Match customers to appropriate products by applying expert and logic rules
Display results to customer
Display product rating and expert feedback
Utilize direct and indirect customer feedback to continuously refine results

Steps may happen in parallel or successively (although not necessarily in this order), and most steps are performed more than once.

### Additional Information is Included Elsewhere in the Specification.

### System Components

### Ontology

Our system uses one or more Ontology(ies) to render a shared vocabulary and taxonomy which models the domain (or sphere of knowledge) with the definition of objects/concepts, as well as their properties and relations. These in turn are used by the other system components.

Ontology components include:
Classes—Sets, types of objects or attributes
Attributes—Aspects, properties, features, characteristics, or parameters of objects or classes
Relations—Ways in which classes and individuals can be related to one another
Function terms—Complex structures formed from certain relations that can be used in place of an individual term in a statement
Restrictions—Formally stated descriptions of what must be true in order for some assertion to be true and/or accepted as input
Rules—Logical inferences that can be drawn from specific assertions

### Expert Rules Interface

The Expert Rules Interface acquires the expert knowledge and creates the rules for the Rules Base. A detailed description is included elsewhere in the specification.

### The Rules Base

The Rules Base includes expert and logic rules for categorizing customers and products (based on both objective and subjective criteria), analyzing products to identify appropriate matches, attributes and/or combinations of attributes when categories are combined and addressing conflicts and exceptions based on expert weighing guidelines and the customer's priorities.

The Apparel & Accessories Rules Base consists of six basic Rule Categories: Universal, Flatter, Fit & Size, Taste & Style, Preferences & Lifestyle, and Combination. Each Rule Category contains the aforementioned expert and logic rules needed to meet the category's distinct goals. These include:
Universal Rules—Rules which are used throughout the Rules Base. One example is the rule(s) for identifying colors and relevant color properties and attributes, as perceived by the human visual system, and which is used in many of the flatter, taste and cross-selling rules. Additional information is included elsewhere in the specification.
Flatter Rules—Rules for categorizing customers and products, analyzing products to identify items and/or combinations of items that flatter the customer, assigning weights and addressing conflicts and exceptions.
Rules for categorizing customers include: body shape and proportions, individual features, specific problem areas, coloring, the customers' feelings about their best and worst attributes, the features they like to highlight, and the attributes they prefer minimizing or enhancing.
Rules for categorizing products include: garment's silhouette, styling details and specific placement of those details, color and placement of color, and texture and drape of fabric.
Fit & Size Rules—Rules for categorizing customers and products, analyzing products to identify items that fit and appropriate size, assigning weights and addressing conflicts and exceptions.
Rules for categorizing customers include: measurements, usage of modifying garments, and fit preferences.
Rules for categorizing products include: garment's measurements, fabric properties (including range of movement and production shrinkage) and design intent.
Taste & Style Rules—Rules for categorizing customers and products, analyzing products to identify items and/or combinations of items matching the customer's taste and style preferences, assigning weights and addressing conflicts and exceptions.
Rules for categorizing customers include: taste, including overall fashion sensibility, degree of trendiness, and preferences for specific styles or features, as well their preferences regarding color and fabric patterns. In addition, the degree to which a customer accessorizes may be considered when recommending complete outfits.
Rules for categorizing products include: overall taste category, current fashion trends and degree of trendiness, specific style and design features, colors, and fabric patterns.
Personal Preferences & Lifestyle Relevance Rules—Rules for categorizing customers and products, analyzing products to identify items and/or combinations of items matching the customer's personal preferences and lifestyle needs, assigning weights and addressing conflicts and exceptions.
Rules for categorizing customers include: preferences regarding price, color and specific fabric attributes (i.e. content, properties and care), and lifestyle factors such as how they generally dress for daytime and evening, and their preference regarding multi-purpose and/or seasonless clothing.
Rules for categorizing products include: price, color, fabric attributes (content, properties, care and weight), style details which determine occasion suitability (i.e. product type, silhouette, trim, occasions and/or categories assigned by the manufacturer or retailer, occasions and/or categories assigned to the brand or retailer in our Indexing Engine), and style details which determine whether an item is season specific or seasonless (i.e. fabric content and weight, silhouette, colors, etc.).
Combination Rules—This addresses the way the aforementioned Rule Categories interact with each other. Includes rules for assigning weights to individual attributes and/or combinations of attributes when categories are combined, and for addressing conflicts and exceptions based on expert weighing guidelines and the customer's priorities.

Rules consist of IF . . . THEN . . . , and both parts of the statement may include several elements. Rules utilize the Ontology (see above) and the elements described below in the Rules Interface, and may also reference other Rules.

Additional information, including details regarding the structure and elements of rules and how rules are created, is included elsewhere in the specification.

### Indexing Engine

The Indexing Engine uses the expert and logic rules in the Rules Base to categorize customers and products. The Customer Indexing Engine and Product Indexing Engine assign a vector, or list of attributes, to each person or product, which are then stored in the Customer Database(s) or Product & Inventory Index(es) respectively.

Each human attribute corresponds to a particular characteristic of that individuals' criteria (flatter, fit, personal style, price and lifestyle preferences and requirements). Attribute examples include: measurements, proportions or descriptions of specific elements of the body, or specific styles and colors they like or dislike.

Each product attribute corresponds to a particular characteristic of the product. Attribute examples include fabric content, fabric properties and color.

Additional information is included elsewhere in the specification.

### Inference Engine

The Inference Engine generates expert recommendations by applying the expert and logic rules in the Rules Base to customer and product vectors. The Inference Engine may also utilize temporary attributes such as search filters.

### Explanation Module

The Explanation Module elucidates how conclusions were made by providing details of the specific pros and cons of an item as it relates to the customers profile.

Additional information is included elsewhere in the specification.

### User Interface

The User Interface obtains customer and product information (input) and communicates with users (output)

Additional information is included elsewhere in the specification.

### Additional Selling, Merchandising and Marketing Tools

Analysis and recommendations may be utilized in several ways, including these unique selling, merchandising and marketing tools: Creating a personalized boutique; Product rating & expert feedback; Automated cross-selling; Improved search tools (i.e. Shop by Body Type, Smart Search, and Fashion Flip Book); Gift program, Wardrobing tools (i.e. Shop by Event, Shopping List, My Personal Stylist, Wardrobe Builder and Instant Makeover); Targeted marketing; Merchandising tools and reports.

Additional information is included elsewhere in the specification.

### Interface & Method for Creating Rules

The Expert Rules Interface acquires the expert knowledge and creates the rules for the Rules Base. Our novel methodology automates much of the process for creating the rules (back end of the Interface), and provides a unique and intuitive process for acquiring both the explicit and implicit expert knowledge (front end).

By parsing the components of thousands of rules, we discovered that almost all the rules consist of a relatively small number of core attributes and rules (a combination of expert rules and scientific principles, or Principles), combined with a small set of rules that governs the specific ways in which these attributes and/or rules interact and combine (Process Rules). Moreover, by deconstructing the logic and structure of the resulting rules and defining the relevant objects, relationships and properties through the Ontology(ies), algorithms and rules, much of the process for creating the relevant rules can be automated.

Equally important, designing the interface in this way results in greater consistency and more accurate rules. Defining the relevant structure and information (vocabulary, properties, elements, etc.) produces uniform rules with minimal human bias. Moreover, experts don't need to adjust the way they think because the User Interface can present the scenario in a format which mimics their real-world decision making. This is important not only because it is a far easier and more natural process, but because the resulting rules more accurate reflect the expert decision making process. Expertise is based on the making of immediate, unreflective situational responses; If one asks an expert for the rules he or she is using, it often forces the expert to regress to the level of a beginner and state the rules that they learned while in school or training, as opposed to the stored experience of the actual outcomes of thousands of situations. (Dreyfus & Dreyfus, 2005)

In addition, expert systems generally require expertise from domain experts (a person with special knowledge or skills in a particular area or topic) in a variety of fields, and this method simplifies the process of acquiring and utilizing expertise from a variety of domains. Furthermore, the process is structured in such a way that much of input required doesn't require the level of expertise as would otherwise be required, and can therefore be performed by individuals with less domain expertise.

### Components for Formulating Rules

Rules consist of IF . . . THEN . . . , and both parts of the statement may include several elements. Rules utilize the Ontology (see above), and may also reference other Rules.

One method for constructing rules from the Attributes, Principles and Process Rules uses specific rule elements and the Interface Rules Base. Rule elements may include: Customer and/or Product Attributes, desired Objective and/or Goal (subset of Objective), Methods for achieving Objective or Goal, and Specific Examples or Applications of the Method. The Interface Rules Base may include: Core Rules; Application Rules which define how Core Rules are combined and applied to customers and products; and Process Rules, which are used by other rules and define methods, relationships and connections, as well as Principles.

The process may be broken down into several additional components in order to replicate the cognitive process which the human mind intuitively takes.

One method of doing this for apparel is outlined below.

### Elements of Rules

Rules include three or more of the following elements:
Customer and/or Product Attributes
Objective—Desired result, overall or for specific attribute
Goal—Method Class for achieving an Objective, overall or for specific attribute
Parent Method—A specific method for achieving a desired Goal
Child Method—Specific attributes, attribute sets and/or subsets within the Parent Method
Grandchild Method—Subset or specific applications of Child Method
Specific Examples or Applications—Some or all of the aforementioned elements are combined with Specific Applications
   Examples of Elements (with Sample Values):

Objective: minimize, maximize, diminish affect of cellulite/muscle tone

Goals for ‘minimize’: decrease size/appearance, avoid increasing size/appearance, decrease visual focus, draw eye elsewhere, smooth out, decrease roundness/curves, conceal

Parent Methods for ‘decrease size/appearance’: dark colors, stiff fabrics, stiff trim, vertical lines, diagonal lines, specific silhouettes

Child Method for ‘dark colors’: black, navy, charcoal, dark green, brown, indigo, deep red

Grandchild Method for ‘black’: solid (may also identify specific patterns and positions of patterns)

Specific Application: Item dress with a Silhouette of wrap dress

Some, or all, of these elements are combined to create a rule for a particular area/body part. For example:

IF Customer Attribute=‘stomach’ AND Objective=‘minimize’ AND Goal=‘decrease appearance’ AND Parent Method=‘dark colors’ THEN Child Method=‘black’ OR ‘navy’ OR ‘charcoal’ OR ‘dark green’ OR ‘brown’ OR ‘indigo’ OR ‘deep red’

As evidenced above, the elements Objective, Goal, Parent Method, Child Method and Grandchild Method have a hierarchical relationship (in descending order), and each node may have several siblings. Additional information is included elsewhere in the specification.

### Interface Rules Base

These rules are primarily used while formulating rules for the Rules Base, and can be divided into five basic Rule Categories: Principles, Process Rules, Core Rules, Customer Application Rules, and Product Application Rules.
Principles—The core expert rules and scientific principles which are used to form most rules. These may work in conjunction with The Expert Rules Interface elements and rules, and/or replace some of them. Additional information is included elsewhere in the specification.
Process Rules—Form the methods, relationships and connections used by other rules, utilizing two or more of the following elements: Objective, Goal, Parent Method, and Child Method. Additional information is included elsewhere in the specification.
Core Rules—May be defined directly or by applying Process Rules to specific customers and/or product attributes; Weights are assigned to individual rules in relation to other rules which achieve the same or similar Goal as well as to specific combinations of rules.
Customer Application Rules—Define how Core Rules are combined in order to apply them to people. This includes identifying which rules are used for specific combinations of attributes, and assigning weights to attributes in order to handle multiple and/or conflicting results.
Product Application Rules—Define how Core Rules are combined in order to apply them to products. This includes identifying which rules are used for specific combinations of attributes, and assigning weights to attributes in order to handle multiple and/or conflicting results.

### Examples of Interface Rules (with Sample Values)

Below are several simple examples showing how these rules might be applied to some of the values and classes assigned in the previous section (Elements of Rules) and the next section (The Knowledge Base Behind the Principles and Rules).
Principle—‘Dark Color’: IF ‘dark color’ THEN ‘decrease appearance’ AND ‘decrease visual focus’ AND ‘recede visually’; Lower ‘Lightness’ increases Weight of ‘decrease appearance’;
Process Rule—‘Objective’:
IF Objective=‘minimize’ THEN Goal=‘Goal minimize’; ELSE IF Objective=‘maximize’ THEN Goal=‘Goal maximize’; ELSE IF Objective=‘diminish affect of cellulite/muscle tone [symbol] THEN Goal=‘Goal Muscle Tone/Cellulite’;
Process Rule—‘Goal’:
IF Goal=‘decrease size/appearance’ THEN Parent Method=‘Methods decrease size/appearance’;
Core Rule—‘Minimize Dark Colors’:
IF Goal=‘decrease size/appearance’ AND Parent Method=‘dark colors’ THEN Child Method=‘darkest colors’; Lower Lightness Weight=Higher Rule Weight;
Core Rule—‘Minimize Dark Colors’ (Option 2):
IF Goal=‘decrease size/appearance’ THEN Method=Principles which ‘decrease size/appearance’
Customer Application Rule—‘Minimize Stomach’:
IF Customer Attribute=‘stomach’ AND Rules=‘Core Rule Minimize Dark Colors’ AND Child Method=‘black’ THEN Rule Weight=10;
Product Application Rule—‘Minimize Stomach—Wrap Dress’:
IF Item=Dress' AND Silhouette=‘Wrap’ AND Customer Application Rules=‘Minimize stomach’ THEN Rule Weight=8;

As explained below, there are several different methods for classifying and analyzing most attributes and rules. The methods chosen, as well as the nature of the rule itself, determine which Expert Interface elements and rules are used and how they are combined.

Two possible options for combining these examples to form rules:
Option 1—Process Rules are used to connect the selected Objective to the correct Goal and the Goal to the correct Parent Method; the Core Rule is used to connect the Parent and Child Methods and assign a rule weight; and the Application Rules are used to connect the Core Rule to specific customer and product attributes, and assign/adjust the rule weight.
Option 2—Connect the Objective to the Goal with the Process Rules; call the Principle with the Core Rule (Option 2; and then use the Application Rules to connect it to specific customer and product attributes and adjust the rule weight.

Additional information is included elsewhere in the specification.

### Principles: The Root of Most Rules

While there are thousands of expert rules, most of the rules are formed by applying a relatively small number of underlying concepts based on the core expert rules and scientific principles.

One such example is the simple expert rule: Black is slimming. The primary reasons why black is slimming are because dark colors:
1) Cause areas to appear smaller
2) Cause areas to recede visually
3) Minimize visual focus
4) Cause details of customers' body attributes to be less noticeable. Visually registers more as an overall shape or silhouette, and the lines which form the body's shape appear smoother.

Secondary, or auxiliary, factors are:
5) The darker a color is, the more it achieves the aforementioned properties
6) Black absorbs all light and therefore achieves the aforementioned properties far more than any other dark color

Reasons 1-4 are Principles, and reasons 5-6 affect the extent to which it achieves the Principle's affect. These in turn form the cornerstone of many expert rules—which are formed by applying them in various ways to make specific areas look smaller, or applying the Principle's inverse to achieve the opposite effect.

### How Principles are Structured

Specific attributes and/or terms identified in each Principle may be individual values and/or Classes of values; and like all of the system's rules, Principles use the shared vocabulary and taxonomy from the Ontology(ies).

Weights may be assigned to indicate the strength of the results delivered by specific values/class of values and/or by specific individual/combinations of Principles or rules. These weights may be assigned in relation to other values/class of values, and/or in relation to specific Principles or Rules. For example (sorted in descending order of weight), dark colors may be divided into three classes: 1) Very dark colors, 2) Medium-dark colors, and 3) Light-dark colors; and the very dark colors class may include the values: black, dark blue, dark gray. Weights for classes of attributes or values may also be assigned in the Ontology(ies).

One method for structuring Principles is by creating simple Rules using IF . . . THEN . . . statements. For example:
IF dark color THEN decreases appearance
IF dark color THEN decreases visual focus
IF light color OR bright color THEN draws visual focus

Principles may be used to form connections between Goals and Methods (including Parent, Child, and Grandchild), instead of Process Rules. Additional information is included elsewhere in the specification.

The Expert User Interface (Front-End)

By breaking the rules down in this way, the system can loop through the various combinations and automatically generate most of the rules. This eliminates most of the time and effort required of experts, because they only have to create a small number of rules and can skip straight to the validation process for most rules. In addition, it is far easier and more natural to identify incorrect or missing knowledge and/or logic when shown unexpected results, than it is to identify all the necessary knowledge and logic in advance, and the resulting rules more accurate reflect the expert decision making process.

Rules are presented to experts in a far more concise format than the one outlined above, because, unlike computers, the human mind is able to make many of the connections on its own and therefore doesn't require many of the elements. Furthermore, the format used for the review process can be even more concise than the one used for creating rules because some of the elements aren't necessary for validating rules. In addition, the logic may be displayed separately from the rule's starting point and endpoint in order to better mirror the nature of intuitive decision-making—which often isn't focused, or even cognizant of the decision-making logic. For example, the Product Application Rule shown above may be presented as a problem (‘minimize stomach’), a solution (‘black wrap dress’), and a score indicating the weight assigned to the solution. In the expanded view it may be presented as one problem and two solutions (color and style), either separately or combined, or it may be structured in a manner that more closely resembles the relevant Core Rule and Application Rules.

Experts using the Rules Interface can adjust or customize each part of the rule(s) which is displayed. In addition, they have access to the remaining items (including elements, rules, principles, and classes) which they may need to adjust or customize.

The format for displaying the components may use a combination of text, graphics and/or images, as well as a variety of UI tools to improve both the expert experience and the resulting rules, and it may be tailored to the specific expert and/or product category.

### The Knowledge Base Behind the Principles and Rules

Most of the attributes and rules can be classified and analyzed in many different ways, including: domain-specific categories and methods; scientific principles; and heuristic shortcuts which draw on knowledge from one or both of the other two (much like the cognitive heuristics process, which are the “fast and frugal” ways that people make decisions, come to judgments, and solve problems when facing computationally complex problems. Additional information is included elsewhere in the specification.

The best approach to take for each particular set of rules (including how relevant attributes are classified and measured) is constantly evolving—in large part due to the huge strides being made in the relevant scientific disciplines to understand the human mind. The preferred embodiment uses a combination of all three approaches.

One relatively simple example of this is the Color attribute, which is used in many of the flatter, taste and cross-selling rules. There are many different ways in which the Color attribute needs to be analyzed and used, and there are several different methods which can be employed for each one of those. These include:
1. Identify the customer and product(s) colors and relevant color properties and attributes, as perceived by the human visual system.
   There are many different Color Spaces or Systems for specifying and classifying colors, and they can generally fall into these categories:
      Systems which model the output of physical devices such as monitors (i.e. CIELAB and HSL)
      Systems which model human visual perception (i.e. Lab, Munsell and OSA-UCS)
      Systems typically used to mix colors for painting and printing (i.e. RGB, CYMK, and Pantone)
   Most Color Spaces have several Color Models, or abstract mathematical models for describing the way colors can be represented and analyzing the effects of colors, including Brightness or Luminance (i.e. HSL, Lab, Munsell and OSA-UCS), using the color properties: Hue, Lightness or Value, and Saturation or Chroma.
   Hue refers to the color name; Lightness or Value refers to how light or dark a color is along a spectrum of black (lowest) to white (highest). The specific terminology used and how it's measured differs by color system—Lightness is used by Lab, OSA-UCS and HSL, and Munsell and HSV refer to it as Value; Chroma or Saturation refers to how strong or weak a color is. The more saturated a color is, the purer the color. The weaker it is, the more gray it has. Chroma is used by Munsell and OSA-UCS, and systems which use Saturation include HSL and HSV.
   The composition of these properties determines a color's Brightness or Luminance, which is an attribute of our perception. Brightness is influenced by a color's Lightness, the hue's individual Luminance value and the Saturation level; of these properties, Lightness has the strongest influence on Brightness.
   In addition, accurately determining product colors from digital information (including manufacturer's product specs) may require an understanding of dye and fiber properties in order determine how well a particular fabric absorbs the color. Properties which affect this include the type of dye, the fiber content, whether the fabric is woven or knit, and density of the yarn or fiber (i.e. thread count, ply or denier).
2. Identify product(s) colors which interact, and how their juxtaposition may affect the color(s) perceived by the human visual system. This can draw on principles in Color Theory regarding color context, as well as principles in Cognitive Science regarding contrast and related visual illusions, including Simultaneous Contrast, Successive Contrast, Induction Effect, Comsweet Illusion, Mach Bands, Checker Shadow Illusion and Bezold Effect. Additional information is included elsewhere in the specification.
3. Determine if the product colors combine with each (Ater, and with the customer, in a visually appealing way based on both Color Theory principles regarding context and harmony and fashion trends.
4. Apply the relevant Flatter and Taste principles and determine how well the color(s) achieve the desired effect.
   Flatter principles are based on expert knowledge in the domain of Wardrobing and principles from Physics and Cognitive Science (including Color Theory and Visual Perception). Some of the specific effects of color as they relate to Flatter include:
      Cause areas to appear smaller or larger
      Cause areas to recede visually or ‘pop out’
      Drawing focus to an area and/or away from other areas
      Cause product details and texture more noticeable or less noticeable
      Cause details of customers' body attributes to be more noticeable or less noticeable
      Complement a customers' skin tone, or negatively affect its perceived appearance
   Taste principles are based on normative modes of dress (both general, and as it relates to specific demographic and/or psychographic profiles), fashion trends, expert knowledge in the domain of Wardrobing, as well as Color Theory principles (such as those explained above and elsewhere in the specification).
   Additional information, including how these translate into rules, is included elsewhere in the specification.

There are many different methods for accomplishing each of these, including using domain-specific categories and methods, scientific principles and theories, as well as heuristic shortcuts which often draw on knowledge from the other two.

For example, two of the possible methods for performing Step 1 (identifying product colors) are:
Utilize a Color Model for one of the Color Spaces based on human visual perception such as the Munsell color, either on its own or together with a formula such as CIE 1964 or CIEDE2000 to identify colors, color properties, and color attributes. Since few, if any, manufacturers use Color Models based on human visual perception, this may also require translating or converting their color information.
Create an Ontology with a shared vocabulary and taxonomy of color names, properties and attributes. One way of doing this is by creating a list of color names and assigning specific values, properties and attributes to each color, either directly or by assigning it to one or more class(es). These classes may also be a ‘parent’ class that is further divided into additional categories. In addition, weights can be assigned to a color class and/or specific color values to rank the relative strength or weakness with which it exhibits an attribute. Weights may also be assigned for specific rules.
For example:
Classes of colors might include: metallic colors, light colors, dark colors, bright colors, jewel tones, pastel colors, earth tones and neutral colors. These classes might be further divided, and dark colors might include three classes, indicating varying degrees of darkness: Dark, Darker and Darkest. A weight for the color property Lightness may be assigned to these classes (i.e. On a scale of 1-10, with 10 being the lightest: Dark=5 Darker=3 Darkest=1).
Colors are then assigned to specific classes (i.e. Black=Darkest, Darker=Brick Red, Dark=Royal Blue), and in addition to any values which they might have been assigned they may be assigned a weight relative to all colors and/or other colors in its class (i.e. in the Darkest class, Black=1, Navy=3, Brown=4, Dark Green=5, Indigo=6, Deep Red=8, and Charcoal=10).

### Areas of Knowledge

Rules for recommending personally relevant clothing, accessories and shoes are largely based on the explicit and implicit knowledge of expert stylists and personal shoppers, who are experts in the domain of wardrobe & grooming recommendations (including clothing, accessories, footwear, make-up, hair, etc.), hereinafter referred to as “Wardrobing”. Developing accurate and comprehensive recommendation rules also requires expertise from several scientific disciplines, including Physics, in particular Color Theory and Mechanics, and Cognitive Science, including Psychology, Neuroscience, Cognitive Neuroscience, Decision Making, and Visual Perception.

‘Expert Rules’ for apparel, accessories and/or shoes refers to a standard fashion sense that fashion industry experts and/or expert stylists use to help select products. For example, horizontal stripes will make a body part look wider, while vertical stripes will make it look elongated. This is expert rule utilizes several principles in Cognitive Science, including Optical illusions regarding lines which are described below.

Relevant Color Theory principles include the extent to which pigments absorb light vs. reflect it, how humans see color, color harmony (which colors go well together), color context which may affect the way color is perceived, as well as which colors complement various skin tones.

Relevant areas within the field of Visual Perception include detecting and processing Light, Color, Shapes, Depth, Contrast and Motion, as well as research regarding Eye Movement (including Fixation and Gaze Direction), and Optical Illusions. Optical Illusions, more properly known as Visual Illusions, are characterized by visually perceived images that differ from objective reality, and are of great interest to cognitive neuroscientist and psychologists because they provide clues to the workings of human visual systems. There are three main types: Literal optical illusions that create images that are different from the objects that make them, Physiological ones that are the effects on the eyes and brain of excessive stimulation of a specific type (brightness, color, size, position, tilt, movement), and Cognitive illusions, the result of unconscious inferences.

Relevant visual illusions include:

Illusory Contours—Illusory contours are treated by the visual system as “real” contours, and illusory brightness and depth ordering frequently accompany illusory contours even though there is no actual change in luminance or color; Examples include: Kanizsa's Triangle and Gestalt's Theory of Reification.

Contrast Effect—The perceived qualities of an object can be effected by the qualities of context (including color, brightness, and sharpness) as a result of immediately previous or simultaneous exposure to a stimulus of lesser or greater value in the same dimension; Examples include: Simultaneous Contrast, Successive Contrast, Induction Effect, Cornsweet Illusion, Mach Bands, Checker Shadow Illusion, Bezold Effect and Chubb Illusion.

Gestalt's Principles of Grouping—The fundamental principle of gestalt perception is that the mind has an innate disposition to perceive patterns in the stimulus based on certain rules. Relevant rules include: Law of Proximity, Law of Closure, Law of Similarity, Law of Symmetry, Law of Common Fate, Law of Continuity, The Principle of Good Continuation, The Principle of Good Form/Gestalt, Law of Past Experience, and Figure-Ground Organization.

Illusions of Length—The tendency to overestimate the length of a vertical line relative to a horizontal line of the same length; The most well known example of this is the Müller-Lyer Illusion.

Illusions of Position—The misperception of the position of one segment of a transverse line that has been interrupted by the contour of an intervening structure; The most well known example of this is the Poggendorff Illusion.

Illusions of Relative Size Perception—The perceived size of an object depends not only on its retinal size, but also on the size of objects in its immediate visual environment, distance from those objects, and the completeness of the surrounding form; Examples include: Delboeuf Illusion, Ebbinghaus Illusion, Hering Illusion, Sander Illusion, Ponzo Illusion, Müller-Lyer, fast row Illusion and Wundt.

Illusions of Straightness of Lines—Two straight and parallel lines look as if they were bowed; Examples include the Hering Illusion and Wundt Illusion.

Illusions of Vertical/Horizontal Size—The vertical extension appears exaggerated; The most well known example of this is the Vertical-horizontal Illusion.

Additional information is included elsewhere in the specification.

### Utilizing Analysis and Recommendations

Our technology can integrate seamlessly into a retailer's website and in-store applications, and provides recommendations across all channels.

Analysis and recommendations may be utilized in several ways, including these unique selling, merchandising and marketing tools:
Personalized Boutique—Displays personally relevant items while user is browsing retailer's website and digital applications, in order from best to worst match.
Fast Browsing—Shop by Body Type and Smart Search functionality allow unregistered customers to benefit from key features in less than 30 seconds, by specifying several parameters. In addition, Smart Search enables retailers to provide personalized search results to registered users throughout their site. Shop by Body Type and Smart Search can be integrated into a retailers existing search functionality.
Women's parameters may include general body shape, bust size, size/size range, key measurements which affect size (i.e. pant size/length or height), product category, personal style, occasion, color, fabric content, price range, sale items and key words. Search results can incorporate relevant profile information for registered users unless they've specified other search criteria or have chosen to suppress their profile.
The Fashion Flip Book allows customers to view all recommended products on one page, without clicking or scrolling, by initiating a looped sequence of all products in each category. The customer is able to control the speed at which they view products and images can be substantially larger than the standard thumbnail image used when viewing a large number of garments.
Automated Cross-selling—Identifies items that look good together and combine properly to create an outfit, and that a customer will look good in and like when combined, based upon principals of color, proportions and fashion, and current trends.
Product Rating & Expert Feedback—Rates quality of match based on expert weighing guidelines and the customer's priorities. Rating is displayed alone or together with a comprehensive but user-friendly description of the specific pros and cons of the item as it relates to their profile, increasing consumer confidence in product recommendations.
Gift Program—Once a customer has completed a profile, family and friends can easily find gifts that will fit and flatter the recipient and be to their liking. Gift shoppers can search by items on the Shopping List, product category, product use, price range and color.
The Gift Program allows users to receive gifts they'll love without the need for creating a registry or sharing account information and compromising their privacy, as gift ideas can be viewed by inputting identifying data which family and friends are likely to know (i.e. name, telephone number, e-mail address and/or mailing address). Users may customize their privacy settings and choose to exclude size information (gifts would be shipped directly to them), limit the product categories shown, and/or limit access to people who know their Gift Program ID.
Wardrobing—Shop by Event selects appropriate products for a specific occasion. Customers can specify a specific occasion or detailed scenario (i.e. work related event+wedding+daytime) and our technology will recommend appropriate products. Shopping List recommends key items to build out and/or update their wardrobe based upon analysis of customer's closet (items purchased from participating retailers as well as items input manually), their profile, and current fashion trends. Shopping List will also note items that may need to be replaced based upon expected lifecycle of products and customer's lifestyle and shopping patterns. My Personal Stylist will combine these functionalities to recommend specific items or complete outfits from a customer's closet, and may be offered directly to customers on a subscription basis.
Additional wardrobing tools include Wardrobe Builder and Instant Makeover. Wardrobe Builder creates multiple looks by combining a minimal number of garments. Instant Makeover provides a real-time makeover based on the customer's profile. Multiple looks are suggested and customers can purchase an ensemble with just two clicks.
Targeted Marketing—Showcases personally relevant products in online and offline marketing efforts (including email, mobile and catalog campaigns, online advertising, and in-store digital signage and personalization efforts), and allows retailers to deliver customized campaigns to consumers when introducing new products, announcing sales events, and clearing out odd lots.
Merchandising Information—Compiles aggregate data for manufacturers and retailers of their customers' body shape and measurements, detailed taste and design preferences and aversions (including specific styles and features), as well as pricing preferences and lifestyle needs. In addition, the Trend Spotter will track browsing and purchasing patterns to determine specific trends on a granular level.
Search Criteria—Identifies items by one or several criteria and/or attributes. Women's apparel criteria might include: general body shape (ratio of shoulders, waist & hips); bust size; clothing size/sizes usually wear; basic measurements such as height or pant size/length; product categories; taste categories; occasion/event categories; silhouettes; specific items; specific trends; colors; fabric properties (i.e. content, stretch, care); price range; sale items; new items; and keyword(s). In addition, it can utilize any merchant search options.
Search criteria can also incorporate registered user's profile information.

### Obtaining & Utilizing Customer & Product Attributes

### Methods for Obtaining Customer Information

Our technology develops an accurate and comprehensive understanding of the customer through explicit user input, behavioral analysis, expert rules and logic. Explicit user input is obtained with an easy-to-use but comprehensive questionnaire, and conjoint analysis (asking a customer his/her preferences between a series of pairs) is utilized to ensure that user input is correctly interpreted and to develop a better understanding of their taste and lifestyle. In addition, artificial intelligence may continuously analyze the customer's feedback as well as their browsing and purchase history to develop a deeper understanding of the customer, and to recommend items that complement items purchased and/or core items to update their existing wardrobe.

Customer information may be obtained through several means, most of which are part of the User Interface. This includes the profiling process described below; general and detailed customer feedback regarding items viewed, purchased, or returned; and by the customer manually adding clothing they already own to My Closet. In addition, the customer's browsing, purchase and returns history may be utilized, as well as profiles created and/or account information stored with retailer and/or technology companies we have partnered or are affiliated with.

Users can choose to create a QuickStart or Comprehensive profile, which usually takes between 3-5 minutes and 15-20 minutes respectively to complete; less if accessing a measurement profile created at a partner company. Alternatively, Shop by Body Type allows new users to benefit from key features in about 30 seconds or less. Users may switch between profile modes at any point and carry over the information they've provided, and/or submit an incomplete profile and start shopping. Users may answer any incomplete questions or edit profile information directly from their account page, and can readily identify unanswered questions. In the interim, our technology may occasionally prompt users with an unanswered question and may utilize behavioral analysis and other profile information provided to fill-in gaps in their profile, and will differentiate between questions which were kept at the default setting and unanswered questions. In addition, users may create Alternate Profiles to accommodate specific occasions or needs that may differ from their standard profile (usually takes 15 seconds-2 minutes).

Our technology utilizes multiple methods for obtaining customer's measurements to increase customer convenience and accessibility. To achieve the most accurate recommendations, customers may measure themselves or provide that information by accessing their measurement profile created at a partner company (via body scanner or specialized software which extracts measurements from photographs). We also offer a quick and simple questionnaire, which can be used to approximate a customer's measurements and proportions and create more generalized product recommendations.

Our technology utilizes several additional tools to minimize the effort required by users. Both the number of clicks required and the need for lengthy instructions may be minimized by using images to represent the choices for complex fields such as general body shapes, specific body parts and descriptions, colors, fabric patterns, and specific styles or design features. In addition, the input required of users may be minimized by pre-setting fields to their most likely answer (generally the average or mid-point answer, or when relevant, to reflect the information already provided), while allowing users to readily identify the fields which they haven't touched. One method for distinguishing between fields which they've intentionally left on the default settings versus unanswered questions may be based upon whether or not they've answered subsequent questions within that profile format.

QuickStart and Comprehensive profiles may be divided into several steps, and one way of doing so is to divide it into four steps: Create Account, My Body, My Taste, and My Lifestyle. Unregistered users may Shop by Body Type without creating an account, and user input may be stored on a cookie for the duration of that session and can be added to their account if one is created mid-session.

Portable Profiles

Customer profiles are accessible at any participating retailer, thereby creating an even stronger value proposition for consumers.

### Customer Information Obtained (Women's Apparel)

Below is a non-exhaustive list of details which may be obtained as they relate to women's apparel. Similar information will be obtained for men's products, as well as for accessories and footwear, and other consumer products and services. It is understood that details not listed here may be obtained as well.

### Comprehensive Profile Information

Body Shape and Proportions
   Measurements of multiple body parts
   Description of shape, size or muscle tone of specific body parts (multiple primary and secondary body issues issues)
   Use of modifying garments (i.e. padded bra or high heels) and degree of modification
Additional Body Data
   Customer's coloring and facial appearance
   Clothing size/sizes usually wear
Subjective Fit & Flatter Issues
   Fit preferences including how fitted like wearing clothing, and preferred waistband position on pants or jeans.
   Specific body parts user likes to emphasize. May also ask the user for specific goals they like to achieve (i.e. likes showing their legs and they like elongating)
   Specific body parts which bother them and the description of those attributes, if not yet determined by previous body shape questions and/or their measurements. Users may specify the degree of importance of each issue. May also ask user for specific goals like to achieve. (i.e. make bust look bigger)
Taste
   Define personal style (select multiple style categories). User ranks choices in descending order of importance.
   Types of styles like/dislike. This includes varying degrees of intricacy in design, and brightness and boldness of prints.
   Specific fabric patterns like/dislike
   Likelihood of experimenting with new styles and need for variety in styles
   Refine definition of taste by selecting between a series of pairs the styles which more likely/prefer to wear. If answer is neither A nor B user may be prompted with a question in order to improve results.
Pairs shown are dependent upon user's input, both before and during this question.
Specific Styles and Design Features Like/Dislike
   Specific styles and lengths of pants, skirts/dresses, necklines and sleeves. Optional exclusion of pants or skirts from results unless specifically searching by those categories.
   How revealing they dress for day and night and specific preferences (i.e. degree of high/low cut neckline).
Fabric Preferences or Aversions
   Colors
   Fabric content. User may specify by category.
   Fabric properties (i.e. stretch, seasonless, wrinkle resistant). User may specify by category.
   Fabric Care. User may specify by category.
Lifestyle Needs
   Preferences regarding variety and trendiness vs. investment pieces
   Preferred price ranges for product categories (i.e. jeans, skirts, dresses). User may specify preferences for investment pieces and/or by specific subcategories (i.e. daytime, casual, summer).
   Lifestyle appropriate styling based upon their typical daytime and evening styles and dress codes, frequency of use, preferences regarding comfort, multi-purpose clothing or low maintenance clothing.
   Degree of accessorizing they do to complete a look
   Demographic and geographic factors which may affect clothing choices (age and zip code)
Customer Settings
   Users may modify the pre-assigned weights of key factors by specifying order of importance of Flatter, Fit, Fashionable, Price & Comfort.
   Request notification of new arrivals and/or sale items matching profile
   Enhanced gift privacy settings or opt out of gift program

### QuickStart Profile Information

Body Shape and Proportions
   Key measurements
   Description of shape, size or muscle tone of key body parts
   Clothing size/sizes usually wear
Subjective Fit & Flatter Issues
   How fitted they like their clothing
   Specific body parts like to emphasize (in descending order of importance)
   Specific body parts which bother them (in descending order of importance)
Taste
   Define personal style (select multiple style categories). Taste category may be modified based upon the zip code they registered with.
   Color preferences
Specific Styles and Design Features Like/Dislike
   Specific styles of pants and lengths for pants and skirts. Optional exclusion of pants or skirts from results unless specifically searching by those categories.
Fabric Preferences or Aversions
   Fabric content
   Fabric properties (stretch or wrinkle resistant)
   Fabric care
Lifestyle Factors
   Define personal style (select multiple style categories). User ranks choices in descending order of importance.
   Preferred price range for product categories (i.e. jeans, skirts, dresses)
   Climate related factors based upon the zip code they registered with
Customer Settings
   Request notification of new arrivals and/or sale items matching profile
   Enhanced gift privacy settings or opt out of gift program

### Shop by Body Type Information

Body Shape and Proportions
   General body shape (ratio of shoulders, waist & hips).
   Bust size
   Clothing size/sizes usually wear
   Basic measurements such as height or pant size/length
Other Search Criteria
   Product category
   Taste categories
   Occasion/Event categories
   Specific silhouettes, items or trend
   Color
   Fabric properties (i.e. content, stretch, care)
   Price range
   Sale items or new items
   Modify by keyword(s)
Search criteria can also incorporate registered user's profile information

### Alternate Means for Obtaining Measurements, Body Shape & Proportions

Accessing a measurement profile created with partner company.
Estimate measurements and proportions by obtaining: body shape (by some or all means described in this document), average size they wear (see below), bra size, height, weight, age, fitness level.
Reverse engineering unmodified garments that fit them well

### Product Attributes Utilized (Women's Apparel)

Product properties assessed include:
Pattern measurements (with information for each size)
Designer's fit intent
Fabric properties (including stretch, seasonless, wrinkle resistance, and production shrinkage)
Comfort factors (i.e. range of movement)
Garment silhouette (i.e. A-line or tapered skirt)
Specific styling features (i.e. specific neckline styles)
Specific styling details (i.e. trim, pockets or embellishments)
Placement of styling details (i.e. seam or pocket placement)
Texture and drape of fabric
Color and placement of color
Fabric design or pattern
Taste category/categories
Relevant occasions for specific taste categories
Fabric content & care
Price
Brand
Manufacturer's & retailer's style and SKU information (including style name & number, collection name and season, and SKU information. May also utilize the items being paired together with it by the manufacturer and/or retailer)

The forgoing merely illustrates the principles of the present invention. It will thus be appreciated that those skilled in the art will be able to devise numerous arrangements which, although not explicitly shown or described herein, embody those principles and are within their spirit and scope.

We claim:

1. A computer implemented method, comprising:
(a) identifying, by the computer, a consumer's data;
(b) distilling, by the computer, the identified consumer data;
(c) identifying, by the computer and based on the identified consumer's data, relevant consumer attributes;
(d) analyzing, by the computer, the identified relevant consumer attributes;
(e) identifying, by the computer, criteria, comprising two or more of: desired results, product attributes to include, and product attributes to exclude;
wherein the desired results are based upon at least one of the following: scientific principles, expert rules, consumer's objectives, consumer's goals, consumer's taste category, consumer's dress code, and consumer's lifestyle;
(f) assessing, by the computer, the identified criteria;
(g) generating, by the computer, weights based on relative importance of the relevant criteria;
(h) assigning, by the computer, said weights, to the consumer data;
(i) assessing, by the computer, interactions between at least one of: consumer attributes and relevant criteria;
wherein said interactions comprise at least one of: within and amongst categories;
(j) processing, by the computer, the consumer data based upon one or more of: rules and methodologies, from one or more rules bases;
(k) placing, by the computer, the consumer data into storage;
(l) identifying, by the computer, product data, comprising product attributes;
(m) distilling, by the computer, the product data;
(n) identifying, by the computer, relevant product attributes;
(o) analyzing, by the computer, the relevant product attributes;
(p) determining, by the computer, associated effects delivered by the product attributes;
(q) assessing, by the computer, interactions between at least one of: product attributes and effects;
wherein said interactions comprise at least one of the following: within categories, amongst the categories, within an element, when combined with other said elements, within an object, and when combined with other said objects;
(r) generating, by the computer, weights indicating strength of the effects delivered by one or more of the following: specific values, types of values, specific product attributes, types of product attributes, specific rules, and types of rules, individually, in combination with one another, and in relation to one another;
(s) assigning, by the computer, said weights to the product data;
(t) processing, by the computer, the product data, wherein said processing is based upon one or more of: said rules and methodologies, from the rules base;
(u) placing, by the computer, the product data into said storage;
(v) passing, by the computer, the consumer data and the product data to one or more rules engines;
(w) matching, by the computer, said products to the consumer data based upon the rules and methodologies residing in the one or more rules engines;
(x) assessing, by the computer, relevance of the product in relation to the consumer data;
(y) ranking, by the computer, the products, based on the assessing according to quality of the match;
(z) generating, by the computer, ranking results of operations (v) through (y); and
(aa) transmitting, by the computer, said ranking results of operations to the storage or user.

2. The computer implemented method of claim 1,
(a) wherein said rules base is further utilized to execute one or more of the following:
(i) generating match details, comprising at least one of the following: products' match rating, size recommendations, color recommendations, expert feedback, positive aspects of match, and negative aspects of match;
(ii) displaying at least one of: highest ranked products and match details, wherein said products comprise one or more of: product, product combinations, and complementary products;
(iii) identifying said complementary products, wherein the complementary products comprise one or more of: products that combine properly to create a desired totality, and products which are personally relevant, individually and/or when combined;
(iv) identifying appropriate products and/or combinations of products for a specific occasion and/or detailed scenario;
(v) identifying key items to add to the consumer's existing product set based upon one or more of: consumer's attributes, items the consumer owns, current trends, expert recommendations, expected lifecycle of products, and consumer's lifestyle and/or shopping patterns; and
(vi) creating multiple looks by combining a minimal number of products; and
(b) wherein the storage comprises one or more of the following: temporary, permanent, local, remote, and any other type of storage available.

3. The computer implemented method of claim 1,
(a) wherein said attributes associated with one or more of: consumer, product, and immediate environment, further comprises one or more of: attributes, objects, elements, and properties;
(b) wherein processing the consumer's data and product data further comprises at least one of:
(i) categorizing the consumer data;
(ii) identifying relevant said objects and said elements within the consumer data;
(iii) assessing the relevant consumer objects and elements;
(iv) assigning a vector of attributes to the consumer;
(v) assessing one or more of: consumer's feedback, behavior, search criteria, and alternate consumer data;
(vi) determining adjustments required to one or more of: consumer attributes, effects, and weights;
(vii) addressing conflicts arising within and/or between one or more of: relevant criteria, effects, and weights, and modifying accordingly;
(viii) categorizing the product data;
(ix) identifying relevant said objects and said elements within the product data;
(x) assessing the relevant product objects and elements; and
(xi) assigning a vector of attributes to the product;
(c) wherein the rules base utilizes rules, comprising the scientific principles and/or expert rules, comprising one or more of the following: general expert rules, domain specific expert rules, general heuristic rules, domain specific heuristic rules, general logic rules, and domain specific logic rules, to execute operations comprising one or more of the following:
(i) identifying one or more of: attributes, objects, elements, properties, and criteria;
(ii) identifying one or more of relevant: attributes, objects, elements, properties, and criteria;
(iii) distilling the data;
(iv) categorizing the data;
(v) analyzing one or more of the relevant: attributes, objects, elements, criteria, and properties;
(vi) determining relevant said effects;
(vii) assessing relevant said effects;
(viii) determining relevant said methodologies for achieving the effects;
(ix) assessing said methodologies;
(x) deploying said methodologies;
(xi) assigning said weights indicating the relative strength of one or more of: criteria, effects, and methodologies;
(xii) assessing and addressing interactions with combination rules, wherein said interactions comprise at least one of: within, amongst, and when combined with, and further comprise at least one of: consumer, product, and immediate environment, and at least one of the following: attributes, objects, elements, categories, properties, criteria, weights, effects, methodologies, and rules;
(xiii) assigning weights with combination rules indicating the strength delivered by specific combinations, comprising one or more of the following: values, types of values, classes, attributes, types of attributes, rules, and types of rules;
(xiv) addressing one or more of: conflicts and exceptions;
(xv) matching the relevant consumer data and products;
(xvi) assessing relevance of said matches;
(xvii) ranking said match quality;
(xviii) wherein the effects comprise one or more effect categories of: objectives, goals, and effects; and
(xix) wherein the methodologies comprise one or more methodology categories of: parent methodologies, child methodologies, grandchild methodologies, and specific applications; And
(d) wherein matching the product data to the consumer data further comprises at least one of:
(i) identifying relevant matching determinants, comprising at least one of the following: criteria, effects, methodologies, and properties;
(ii) determining relevant characteristics for matching the products to the customer criteria, comprising one or more of: effects, methodologies, and properties;
(iii) analyzing one or more of the relevant matching determinants;
(iv) assessing interactions;
(v) addressing the interactions;
(vi) determining combination weights;
(vii) assigning said combination weights;
(viii) assessing the interactions to identify one or more of: conflicts and exceptions;
(ix) determining adjustments required to at least one of: attributes, matching determinants, and weights, and adjusting accordingly;
(x) assessing adjusted said relevant matching determinants;
(xi) determining at least one of the relevant: effects and methodologies, for matching the products to the customer criteria within acceptable range;
(xii) deploying the relevant methodologies;
(xiii) identifying the relevant attributes exhibiting one or more of the relevant: effects and methodologies;
(xiv) identifying the products exhibiting the relevant attributes;
(xv) assessing the interactions;
(xvi) determining relevance of the product in relation to the consumer data;
(xvii) determining and assigning match quality weight; and
(xviii) wherein combination interactions comprise at least one of: within, amongst, and when combined with, and further comprise at least one of: consumer, product, and immediate environment, and at least one of the following: attributes, objects, elements, categories, properties, criteria, weights, effects, and rules.

4. The computer implemented method of claim 3,
(a) wherein the consumer and product data is obtained, derived and/or inferred from at least one of the following: data obtained from users, manufacturers, retailers, businesses, service providers, public sources, private sources, domain-specific expert knowledge, aggregate data, and reverse engineering products; and
(b) wherein the consumer and/or product data comprises at least one of the following: detailed product attributes, relevant inventory data, user behavior, and detailed information comprising one or more of the consumer's: attributes, needs, preferences, taste, lifestyle, existing product set, products own, products use, browsing history, purchase history, direct feedback, and indirect feedback;
wherein said user behavior comprises at least one of: browsing history, purchase history, direct feedback, and indirect feedback.

5. The computer implemented method of claim 4,
(a) wherein the consumer attributes utilized by the rules base to execute operations further comprise at least one of the following:
(i) the objectives and/or goals, comprising at least one of: objectives, goals, and assigned importance;
(ii) accounting for one or more of: objective perspective and subjective perspective;
(iii) one or more said taste categories, wherein the taste categories identify at least one of: consumer's overall taste, and taste category results desired;
(iv) taste preferences, comprising at least one of: colors, patterns, product categories, product's overall silhouettes, product's overall styles, style features, style details, and positions, wherein said preferences comprises one or more of: preferences and aversions;
(v) style preferences, comprising at least one of the following: colors, patterns, product categories, product's overall silhouettes, product's overall styles, style features, style details, and positions wherein said preferences comprises one or more of: preferences and aversions;
(vi) experimentation level, determining likelihood of experimenting with one or more of: new products, styles, and trends;
(vii) product combination usage, comprising at least one of: type, usage of accompanying products, and usage of accompanying accessories;
(viii) general dress code, comprising at least one of the following: typical daytime styles, typical daytime dress codes, typical evening styles, typical evening dress codes, frequency of use, and results desired;
(ix) one or more factors which affect product choices, comprising: demographic, psychographic and geographic factors;
(x) lifestyle related preferences, comprising one or more of: preferences and aversions, for one or more of: variety, versatility, seasonality factors, and durability of style;
(xi) materials' attribute preferences, comprising one or more of: preferences and aversions, for at least one of: specific materials' attributes, and specific materials' attribute by category;
(xii) price range, comprising preferred price ranges for one or more of: product types, categories, subcategories, and specific attributes; and
(xiii) category weights specifying said order of importance, comprising at least one of: weights by category and weights by subcategory, wherein said weight values comprise at least one of: pre-assigned, dynamically calculated, modified by user, and input by user; and
(b) wherein the product attributes utilized by the rules base to execute operations further comprise at least one of the following:
(i) silhouette and/or style, comprising at least one of: overall silhouette, overall style, core style features, and style details attributes, comprising one or more of: size, position, shape, style, type, subset categories, components, and construction method;
(ii) size related attributes by element, comprising at least one of: measurements, position, product labeling size, and measurements' relationship to product labeling size;
(iii) fit intent, comprising one or more of: proximity and position, by one or more of: body elements and product elements;
(iv) materials' attributes, comprising at least one of the following: color, pattern, texture, materials' type, construction method, density, weight, size, content, content type, content construction method, content density, content weight, content size, materials' properties derived from content, and materials' properties derived from construction;
(v) price;
(vi) one or more of: demographic, psychographic, and geographic factors;
(vii) assigned categories, wherein said categories are assigned by at least one of the following: inside rules engine, directly by manufacturer, and directly by retailer;
wherein said categories are assigned to at least one of: product, collection, brand, and retailer;
(viii) wherein the categories assigned comprise one or more of the following: overall taste, trendiness, seasonality, relevant occasions, and relevant demographics;
(ix) color;
(x) patterns, comprising appearance or lack thereof, and when present, further comprising at least one of: type, size, and position; and
(xi) textures, comprising appearance or lack thereof, and when present, further comprising at least one of: type, size, and position.

6. The computer implemented method of claim 5, wherein the engine also uses one or more category specific rules bases;
(a) wherein the consumer attributes utilized by the fashion rules base to execute operations further comprises at least one of the following:
(i) one or more of: body shape, body proportions, and body tone, further comprising one or more of the following for overall body and/or individual features: shape, proportions, size, and muscle tone;
wherein said muscle tone comprises one or more of: muscle tone and cellulite;
(ii) measurements, comprising one or more of: consumer's relevant measurements and product labeling sizes usually wear;
(iii) modifying garment attributes, comprising at least one of: usage of modifying products, type, and degree of modification;
(iv) fit preferences, comprising one or more of: proximity and position, by elements, comprising one or more of: body and product;
(v) consumer's facial appearance, comprising at least one of: facial appearance and appearance of surrounding features, and further comprising at least one of: skin and features;
(vi) consumer's coloring, comprising one or more of: overall coloring and coloring of specific features; and
(vii) the objectives and/or goals, comprising one or more of: problem areas, best attributes, specific objectives, specific goals, and assigned importance;
(b) wherein a fashion rules base comprises one or more of the rule categories: flatter, fit, style, and lifestyle and preferences, wherein the fit rule category comprises one or more of: fit and size, and the style rule category comprises one or more of: taste and style;
(c) wherein the attributes utilized by the flatter rule categories to execute operations comprise one or more of:
(i) the consumer attributes utilized comprise at least one of the following: body shape, body proportions, body tone, measurements, modifying garments, coloring, skin appearance, facial appearance, objectives, and goals;
(ii) the product attributes utilized comprise at least one of the following attributes: product's silhouette, product's style, product measurements, product elements, color attributes, pattern attributes, texture attributes, and materials' attributes, and further comprises the position of at least one of the following attributes: product elements, color attributes, pattern attributes, texture attributes, and materials' attributes;
(iii) the elements in immediate environment that interact with the attributes; and
(iv) the attributes in immediate environment that interact with the attributes;
(d) wherein the attributes utilized by the fit rule categories to execute operations comprise one or more of:
(i) the consumer attributes utilized comprise at least one of: measurements, modifying garments, and fit preferences;
(ii) the product attributes utilized comprise at least one of: measurements, product labeling size, fit intent, materials' properties, and comfort factors arising from one or more of: materials' attributes, product's silhouette, style, and measurements;
(iii) the elements in immediate environment that interact with the attributes; and
(iv) the attributes in immediate environment that interact with the attributes;
(e) wherein the attributes utilized by the style rule categories to execute operations comprise one or more of:
(i) the consumer attributes utilized comprise at least one of the following: attributes which determine overall taste category, attributes which determine degree of trendiness, specific preferences, demographic factors, psychographic factors, geographic factors, and product combination usage;
wherein said specific preferences comprises one or more of: preferences and aversions, regarding one or more specific: attributes, attribute types, attribute classes, attribute categories, attribute values, value types, value classes, and value categories, for said attributes comprising at least one of the following: overall taste category, style experimentation level, taste, style, and materials' attributes;
(ii) the product attributes utilized comprise at least one of the following: silhouette, style, measurements, fit intent, color attributes, pattern attributes, texture attributes, materials' attributes, materials' size, materials' position, product details which determine overall taste category, product details which determine degree of trendiness, and categories assigned;
wherein said product details determining one or more of: overall taste category and degree of trendiness, comprise at least one of: product attributes, degree of intricacy, effect on whole of said product attributes, effect on whole of said degree of intricacy, and current fashion trends, and said categories assigned comprise at least one of: overall taste, trendiness, and demographics;
(iii) the elements in immediate environment that interact with the attributes; and
(iv) the attributes in immediate environment that interact with the attributes; and
(f) wherein the attributes utilized by said lifestyle and preferences rule categories to execute operations comprise one or more of:
(i) the consumer attributes utilized comprise at least one of the following: price range, general dress code, relevant preferences, product combination usage, demographic factors, psychographic factors, and geographic factors;
wherein said relevant preferences comprises one or more of: preferences and aversions, regarding one or more specific: attributes, attribute types, attribute classes, attribute categories, attribute values, value types, value classes, and value categories, for said attributes comprising at least one of the following: product categories, colors, patterns, materials' attributes, and lifestyle related factors;
(ii) the product attributes utilized comprise at least one of the following: trend item classification, basic item classification, qualification as investment piece, product attributes and assessments made by one or more of the rule categories to determine degree of versatility, measurements, position and proximity by body and product elements, product category, demographic factors, psychographic factors, geographic factors, product details which determine one or more of: occasion suitability, dress code suitability, and seasonality, products deemed occasion relevant for specific taste categories by style rules, products deemed dress code relevant for specific taste categories by style rules, and categories assigned regarding one or more of: relevant occasions and relevant demographics;
wherein the product details which determine occasion and dress code suitability comprise one or more of: materials' attributes, product silhouette attribute, and style attribute;
wherein seasonality comprises if an item is season specific and relevant seasons, comprising one or more of: color, product silhouette, style, seasonality categories assigned, and materials' attributes, comprising one or more of: content, weight, and climate related properties;
(iii) the elements in immediate environment that interact with the attributes; and
(iv) the attributes in immediate environment that interact with the attributes.

7. The computer implemented method of claim 5,
(a) wherein the methodologies utilized by the rules base comprise at least one of the following:
(i) one or more of: line, shape, direction, color, size, position, and proximity attributes of the elements; and
(ii) one or more of the attributes utilized by the rules bases; and
(b) wherein the rules base further executes operations with rules and methodologies on the data utilizing one or more of the following:
(i) wherein said attribute values are one or more of: actual and visually perceived, and said values comprise one or more of: entity and value;
(ii) wherein said values are affected by interactions with other said values, comprising one or more of: within the element, within the object, and with other said values in immediate environment;
(iii) wherein every said element comprises one or more of: line, shape, color, size, and position attributes;
(iv) wherein the line attribute comprises two or more of the following:
(01) directionality, comprising one or more of: vertical, horizontal, diagonal, and curved;
(02) complexity level;
(03) characteristics, comprising one or more of: explicit, implied, complete, interrupted, silhouette, and solid;
(04) line shape;
(05) direction; and
(06) the color, size, and position attributes;
(v) wherein the shape attribute comprises two or more of the following:
(01) shape categorization, comprising one or more of: shape category and type;
(02) shape characteristics, comprising one or more of the following: explicit, implied, complete, interrupted, silhouette, solid, figure, ground, positive space, negative space, and depth;
(03) the line elements and attributes; and
(04) the color, size, and position attributes;
(vi) wherein the size attribute comprises at least two of: length, width, and depth;
(vii) wherein the position attribute comprises the position's point and distance from said objects in immediate environment, and the position's point comprises at least one of: initial point and terminal point;
(viii) wherein the color attribute comprises one or more of the following:
(01) color representation attributes, comprising one or more of the following: specifying the color represented and describing the color represented;
(02) brightness and/or luminance attributes comprising stemming from at least one of: color attributes, materials' attributes, and other sources of light, brightness, and/or luminance; and
(03) the size and position attributes;
(ix) wherein the direction comprises one or more of the following: direction, degree, and information for measuring the relevant curves;
(x) wherein the lines inherent to the product comprise one or more of: elements, individually and/or in concert with other said elements of the same and/or different type:
(01) the lines which form the product's shapes;
(02) the line attributes of the product's silhouette and/or style elements;
(03) the lines within the materials' attributes; and
(04) the lines within one or more of: pattern and texture elements;
(xi) wherein the shapes inherent to the product comprise one or more of the following elements, individually and/or in concert with other said elements of the same and/or different type:
(01) the shape attributes of the product's silhouette and/or style elements;
(02) the shapes within the materials' attributes; and
(03) the shapes within one or more of: pattern and texture elements;
(xii) wherein every said product element comprises one or more of the following: measurements, materials' attributes, is either solid or patterned, and when present, comprises the patterns' attributes, and is either flat or textured, and when present, comprises the texture attributes; and
(xiii) wherein every said product comprises one or more of the following: product's silhouette attributes, style attributes, categories assigned by manufacturer and/or retailer, and product labeling size, and every fashion product further comprises the fit intent.

8. The computer implemented method of claim 7,
(a) wherein the effects utilized by the rules base to execute operations comprise one or more of the following:
(i) the objectives;
(ii) the goals;
(iii) increasing one or more of: size, curves, and muscle tone, wherein increase is one or more of: actual and visual;
(iv) decreasing one or more of: size, curves, and muscle tone, wherein decrease is one or more of: actual and visual;
(v) smoothing out surfaces, wherein surface smoothness is one or more of: actual and visual;
(vi) texturing surfaces, wherein surface texturing is one or more of: actual and visual;
(vii) affecting one or more of: visual perception and visual attention, through at least one of the following: increasing visual appearance, decreasing visual appearance, making details more noticeable, making details less noticeable, concealing, increasing gaze fixation, decreasing gaze fixation, directing gaze towards the element, and directing gaze away from the element;
(viii) determining visual appeal and/or unappeal of combinations, comprising at least one of: attributes, elements, and objects, wherein said determination is based on factors comprising one or more of the following: trends, normative choices, modes of dress, lifestyle, taste categories, degree of trendiness, lifestyle attributes, demographic factors, psychographic factors, and geographic factors, in general and/or as it relates to the customer, and/or the principles regarding one or more of: proportions, complementing, context, harmony, and visual perception;
wherein said visual perception comprises one or more of: visual perception, visual attention, gestalt's principles, and visual illusions; and
(ix) avoiding inverse of the intended effects.

9. The computer implemented method of claim 6,
(a) wherein the methodologies utilized by the rules base comprise at least one of the following:
(i) one or more of: line, shape, direction, color, size, position, and proximity attributes of the elements; and
(ii) one or more of the attributes utilized by the rules bases; and
(b) wherein the rules base further executes operations with rules and methodologies on the data utilizing one or more of the following:
(i) wherein said attribute values are one or more of: actual and visually perceived, and said values comprise one or more of: entity and value;
(ii) wherein said values are affected by interactions with other said values, comprising one or more of: within the element, within the object, and with other said values in immediate environment;
(iii) wherein every said element comprises one or more of: line, shape, color, size, and position attributes;
(iv) wherein the line attribute comprises two or more of the following:
(01) directionality, comprising one or more of: vertical, horizontal, diagonal, and curved;
(02) complexity level;
(03) characteristics, comprising one or more of: explicit, implied, complete, interrupted, silhouette, and solid;
(04) line shape;
(05) direction; and
(06) the color, size, and position attributes;
(v) wherein the shape attribute comprises two or more of the following:
(01) shape categorization, comprising one or more of: shape category and type;
(02) shape characteristics, comprising one or more of the following: explicit, implied, complete, interrupted, silhouette, solid, figure, ground, positive space, negative space, and depth;
(03) the line elements and attributes; and
(04) the color, size, and position attributes;
(vi) wherein said values are affected by interactions with other said values, comprising one or more of: within the element, within the object, and with other said values in immediate environment;
(vii) wherein the size attribute comprises at least two of: length, width, and depth;
(viii) wherein the position attribute comprises the position's point and distance from said objects in immediate environment, and the position's point comprises at least one of: initial point and terminal point;
(ix) wherein the color attribute comprises one or more of the following:
(01) color representation attributes, comprising one or more of the following: specifying the color represented and describing the color represented;
(02) brightness and/or luminance attributes comprising stemming from at least one of: color attributes, materials' attributes, and other sources of light, brightness, and/or luminance; and
(03) the size and position attributes;
(x) wherein the direction comprises one or more of the following: direction, degree, and information for measuring the relevant curves;
(xi) wherein the lines inherent to the product comprise one or more of: elements, individually and/or in concert with other said elements of the same and/or different type:
(01) the lines which form the product's shapes;
(02) the line attributes of the product's silhouette and/or style elements;
(03) the lines within the materials' attributes; and
(04) the lines within one or more of: pattern and texture elements;
(xii) wherein the shapes inherent to the product comprise one or more of the following elements, individually and/or in concert with other said elements of the same and/or different type:
(01) the shape attributes of the product's silhouette and/or style elements;
(02) the shapes within the materials' attributes; and
(03) the shapes within one or more of: pattern and texture elements;
(xiii) wherein every said product element comprises one or more of the following: measurements, materials' attributes, is either solid or patterned, and when present, comprises the patterns' attributes, and is either flat or textured, and when present, comprises the texture attributes; and
(xiv) wherein every said product comprises one or more of the following: product's silhouette attributes, style attributes, categories assigned by manufacturer and/or retailer, and product labeling size, and every fashion product further comprises the fit intent.

10. The computer implemented method of claim 9,
(a) wherein the effects utilized by the rules base to execute operations comprise one or more of the following:
(i) the objectives;
(ii) the goals;
(iii) increasing one or more of: size, curves, and muscle tone, wherein increase is one or more of: actual and visual;
(iv) decreasing one or more of: size, curves, and muscle tone, wherein decrease is one or more of: actual and visual;
(v) smoothing out surfaces, wherein surface smoothness is one or more of: actual and visual;
(vi) texturing surfaces, wherein surface texturing is one or more of: actual and visual;
(vii) affecting one or more of: visual perception and visual attention, through at least one of the following: increasing visual appearance, decreasing visual appearance, making details more noticeable, making details less noticeable, concealing, increasing gaze fixation, decreasing gaze fixation, directing gaze towards the element, and directing gaze away from the element;
(viii) determining visual appeal and/or unappeal of combinations, comprising at least one of: attributes, elements, and objects, wherein said determination is based on factors comprising one or more of the following: trends, normative choices, modes of dress, lifestyle, taste categories, degree of trendiness, lifestyle attributes, demographic factors, psychographic factors, and geographic factors, in general and/or as it relates to the customer, and/or the principles regarding one or more of: proportions, complementing, context, harmony, and visual perception;
wherein said visual perception comprises one or more of: visual perception, visual attention, gestalt's principles, and visual illusions; and
(ix) avoiding inverse of the intended effects.

11. A computer implemented method, comprising:
(a) identifying, by the computer, a consumer's data;
(b) distilling, by the computer, the identified consumer data;
(c) identifying, by the computer and based on the identified consumer's data, relevant consumer attributes;
(d) categorizing the consumer data;
(e) analyzing, by the computer, the identified relevant consumer attributes;
(f) identifying, by the computer, criteria, comprising two or more of: desired results, product attributes to include, and product attributes to exclude;
wherein the desired results are based upon at least one of the following: scientific principles, expert rules, consumer's objectives, consumer's goals, consumer's taste category, consumer's dress code, and consumer's lifestyle;
(g) assessing, by the computer, the identified criteria;
(h) generating, by the computer, weights based on relative importance of the relevant criteria;
(i) assigning, by the computer, said weights, to the consumer data;
(j) assessing, by the computer, interactions between at least one of: consumer attributes and relevant criteria;
wherein said interactions comprise at least one of: within and amongst categories;
(k) processing, by the computer, the consumer data based upon one or more of: rules and methodologies, from one or more rules bases;
(l) placing, by the computer, the consumer data into storage;
(m) identifying, by the computer, product data, comprising product attributes;
(n) categorizing the product data;
(o) distilling, by the computer, the product data;
(p) identifying, by the computer, relevant product attributes;
(q) analyzing, by the computer, the relevant product attributes;
(r) determining, by the computer, associated effects delivered by the product attributes;
(s) assessing, by the computer, interactions between at least one of: product attributes and effects;
wherein said interactions comprise at least one of the following: within categories, amongst the categories, within an element, when combined with other said elements, within an object, and when combined with other said objects;
(t) generating, by the computer, weights indicating strength of the effects delivered by one or more of the following: specific values, types of values, specific product attributes, types of product attributes, specific rules, and types of rules, individually, in combination with one another, and in relation to one another;
(u) assigning, by the computer, said weights to the product data;
(v) processing, by the computer, the product data, wherein said processing is based upon one or more of: rules and methodologies, from the rules base;
(w) placing, by the computer, the product data into said storage;
(x) passing, by the computer, the consumer data and the product data to one or more rules engines;
(y) matching, by the computer, said products to the consumer data based upon the rules and methodologies residing in the one or more rules engines;
(z) assessing, by the computer, relevance of the product in relation to the consumer data;
(aa) ranking, by the computer, the products, based on the assessing according to quality of the match;
(bb) generating, by the computer, ranking results of operations (v) through (y); and
(cc) transmitting, by the computer, said ranking results of operations to the storage or user.

12. The computer implemented method of claim 11,
(a) wherein said attributes associated with one or more of: consumer, product, and immediate environment, further comprises one or more of: attributes, objects, elements, and properties;
(b) wherein processing the consumer's data and product data further comprises at least one of:
(i) categorizing the consumer data;
(ii) identifying relevant said objects and said elements within the consumer data;
(iii) assessing the relevant consumer objects and elements;
(iv) assigning a vector of attributes to the consumer;
(v) assessing one or more of: consumer's feedback, behavior, search criteria, and alternate consumer data;
(vi) determining adjustments required to one or more of: consumer attributes, effects, and weights;
(vii) addressing conflicts arising within and/or between one or more of: relevant criteria, effects, and weights, and modifying accordingly;
(viii) categorizing the product data;
(ix) identifying relevant said objects and said elements within the product data;
(x) assessing the relevant product objects and elements; and
(xi) assigning a vector of attributes to the product;
(c) wherein the rules base utilizes rules, comprising the scientific principles and/or expert rules, comprising one or more of the following: general expert rules, domain specific expert rules, general heuristic rules, domain specific heuristic rules, general logic rules, and domain specific logic rules, to execute operations, comprising one or more of the following:
(i) identifying one or more of: attributes, objects, elements, properties, and criteria;
(ii) identifying one or more of relevant: attributes, objects, elements, properties, and criteria;
(iii) distilling the data;
(iv) categorizing the data;
(v) analyzing one or more of the relevant: attributes, objects, elements, criteria, and properties;
(vi) determining relevant said effects;
(vii) assessing relevant said effects;
(viii) determining relevant said methodologies for achieving the effects;
(ix) assessing said methodologies;
(x) deploying said methodologies;
(xi) assigning said weights indicating the relative strength of one or more of: criteria, effects, and methodologies;
(xii) assessing and addressing interactions with combination rules, wherein said interactions comprise at least one of: within, amongst, and when combined with, and further comprise at least one of: consumer, product, and immediate environment, and at least one of the following: attributes, objects, elements, categories, properties, criteria, weights, effects, methodologies, and rules;
(xiii) assigning weights with combination rules indicating the strength delivered by specific combinations, comprising one or more of the following: values, types of values, classes, attributes, types of attributes, rules, and types of rules;
(xiv) addressing one or more of: conflicts and exceptions;
(xv) matching the relevant consumer data and products;
(xvi) assessing relevance of said matches;
(xvii) ranking said match quality;
(d) wherein matching the product data to the consumer data further comprises at least one of:
(i) identifying relevant matching determinants, comprising at least one of the following: criteria, effects, methodologies, and properties;
(ii) determining relevant characteristics for matching the products to the customer criteria, comprising one or more of: effects, methodologies, and properties;
(iii) analyzing one or more of the relevant matching determinants;
(iv) assessing interactions;
(v) addressing the interactions;
(vi) determining combination weights;
(vii) assigning said combination weights;
(viii) assessing the interactions to identify one or more of: conflicts and exceptions;
(ix) determining adjustments required to at least one of: attributes, matching determinants, and weights, and adjusting accordingly;
(x) assessing adjusted said relevant matching determinants;
(xi) determining at least one of the relevant: effects and methodologies, for matching the products to the customer criteria within acceptable range;
(xii) deploying the relevant methodologies;
(xiii) identifying the relevant attributes exhibiting one or more of the relevant: effects and methodologies;
(xiv) identifying the products exhibiting the relevant attributes;
(xv) assessing the interactions;
(xvi) determining relevance of the product in relation to the consumer data;
(xvii) determining and assigning match quality weight; and
(xviii) wherein combination interactions comprise at least one of: within, amongst, and when combined with, and further comprise at least one of: consumer, product, and immediate environment, and at least one of the following: attributes, objects, elements, categories, properties, criteria, weights, effects, and rules.

13. The computer implemented method of claim 12,
(a) wherein the consumer attributes utilized by the rules base to execute operations further comprise at least one of the following:
(i) the objectives and/or goals, comprising at least one of: objectives, goals, and assigned importance;
(ii) accounting for one or more of: objective perspective and subjective perspective;
(iii) one or more said taste categories, wherein the taste categories identify at least one of: consumer's overall taste, and taste category results desired;
(iv) taste preferences, comprising at least one of: colors, patterns, product categories, product's overall silhouettes, product's overall styles, style features, style details, and positions, wherein said preferences comprises one or more of: preferences and aversions;
(v) style preferences, comprising at least one of the following: colors, patterns, product categories, product's overall silhouettes, product's overall styles, style features, style details, and positions wherein said preferences comprises one or more of: preferences and aversions;
(vi) experimentation level, determining likelihood of experimenting with one or more of: new products, styles, and trends;
(vii) product combination usage, comprising at least one of: type, usage of accompanying products, and usage of accompanying accessories;
(viii) general dress code, comprising at least one of the following: typical daytime styles, typical daytime dress codes, typical evening styles, typical evening dress codes, frequency of use, and results desired;
(ix) one or more factors which affect product choices, comprising: demographic, psychographic and geographic factors;
(x) lifestyle related preferences, comprising one or more of: preferences and aversions, for one or more of: variety, versatility, seasonality factors, and durability of style;
(xi) materials' attribute preferences, comprising one or more of: preferences and aversions, for at least one of: specific materials' attributes, and specific materials' attribute by category;
(xii) price range, comprising preferred price ranges for one or more of: product types, categories, subcategories, and specific attributes; and
(xiii) category weights specifying said order of importance, comprising at least one of: weights by category and weights by subcategory, wherein said weight values comprise at least one of: pre-assigned, dynamically calculated, modified by user, and input by user; and
(b) wherein the product attributes utilized by the rules base to execute operations further comprise at least one of the following:
(i) silhouette and/or style, comprising at least one of: overall silhouette, overall style, core style features, and style details attributes, comprising one or more of: size, position, shape, style, type, subset categories, components, and construction method;
(ii) size related attributes by element, comprising at least one of: measurements, position, product labeling size, and measurements' relationship to product labeling size;
(iii) fit intent, comprising one or more of: proximity and position, by one or more of: body elements and product elements;
(iv) materials' attributes, comprising at least one of the following: color, pattern, texture, materials' type, construction method, density, weight, size, content, content type, content construction method, content density, content weight, content size, materials' properties derived from content, and materials' properties derived from construction;
(v) price;
(vi) one or more of: demographic, psychographic, and geographic factors;
(vii) assigned categories, wherein said categories are assigned by at least one of the following: inside rules engine, directly by manufacturer, and directly by retailer;
wherein said categories are assigned to at least one of: product, collection, brand, and retailer;
(viii) wherein the categories assigned comprise one or more of the following: overall taste, trendiness, seasonality, relevant occasions, and relevant demographics;
(ix) color;
(x) patterns, comprising appearance or lack thereof, and when present, further comprising at least one of: type, size, and position; and
(xi) textures, comprising appearance or lack thereof, and when present, further comprising at least one of:
type, size, and position.

14. The computer implemented method of claim 13,
(a) wherein the methodologies utilized by the rules base comprise at least one of the following:
(i) one or more of: line, shape, direction, color, size, position, and proximity attributes of the elements; and
(ii) one or more of the attributes utilized by the rules bases; and
(b) wherein the rules base further executes operations with rules and methodologies on the data utilizing one or more of the following:
(i) wherein said attribute values are one or more of: actual and visually perceived, and said values comprise one or more of: entity and value;
(ii) wherein said values are affected by interactions with other said values, comprising one or more of: within the element, within the object, and with other said values in immediate environment;
(iii) wherein every said element comprises one or more of: line, shape, color, size, and position attributes;
(iv) wherein the line attribute comprises two or more of the following:
(01) directionality, comprising one or more of: vertical, horizontal, diagonal, and curved;
(02) complexity level;
(03) characteristics, comprising one or more of: explicit, implied, complete, interrupted, silhouette, and solid;
(04) line shape;
(05) direction; and
(06) the color, size, and position attributes;
(v) wherein the shape attribute comprises two or more of the following:
(01) shape categorization, comprising one or more of: shape category and type;
(02) shape characteristics, comprising one or more of the following: explicit, implied, complete, interrupted, silhouette, solid, figure, ground, positive space, negative space, and depth;
(03) the line elements and attributes; and
(04) the color, size, and position attributes;
(vi) wherein the size attribute comprises at least two of: length, width, and depth;
(vii) wherein the position attribute comprises the position's point and distance from said objects in immediate environment, and the position's point comprises at least one of: initial point and terminal point;
(viii) wherein the color attribute comprises one or more of the following:
(01) color representation attributes, comprising one or more of the following: specifying the color represented and describing the color represented;
(02) brightness and/or luminance attributes comprising stemming from at least one of: color attributes, materials' attributes, and other sources of light, brightness, and/or luminance; and
(03) the size and position attributes;
(ix) wherein the direction comprises one or more of the following: direction, degree, and information for measuring the relevant curves;
(x) wherein the lines inherent to the product comprise one or more of: elements, individually and/or in concert with other said elements of the same and/or different type:
(01) the lines which form the product's shapes;
(02) the line attributes of the product's silhouette and/or style elements;
(03) the lines within the materials' attributes; and
(04) the lines within one or more of: pattern and texture elements;
(xi) wherein the shapes inherent to the product comprise one or more of the following elements, individually and/or in concert with other said elements of the same and/or different type:
(01) the shape attributes of the product's silhouette and/or style elements;
(02) the shapes within the materials' attributes; and
(03) the shapes within one or more of: pattern and texture elements;
(xii) wherein every said product element comprises one or more of the following: measurements, materials' attributes, is either solid or patterned, and when present, comprises the patterns' attributes, and is either flat or textured, and when present, comprises the texture attributes; and
(xiii) wherein every said product comprises one or more of the following: product's silhouette attributes, style attributes, categories assigned by manufacturer and/or retailer, and product labeling size, and every fashion product further comprises the fit intent.

15. The computer implemented method of claim 14,
(a) wherein the effects utilized by the rules base to execute operations comprise one or more of the following:
(i) the objectives;
(ii) the goals;
(iii) increasing one or more of: size, curves, and muscle tone, wherein increase is one or more of: actual and visual;
(iv) decreasing one or more of: size, curves, and muscle tone, wherein decrease is one or more of: actual and visual;
(v) smoothing out surfaces, wherein surface smoothness is one or more of: actual and visual;
(vi) texturing surfaces, wherein surface texturing is one or more of: actual and visual;
(vii) affecting one or more of: visual perception and visual attention, through at least one of the following: increasing visual appearance, decreasing visual appearance, making details more noticeable, making details less noticeable, concealing, increasing gaze fixation, decreasing gaze fixation, directing gaze towards the element, and directing gaze away from the element;
(viii) determining visual appeal and/or unappeal of combinations, comprising at least one of: attributes, elements, and objects, wherein said determination is based on factors comprising one or more of the following: trends, normative choices, modes of dress, lifestyle, taste categories, degree of trendiness, lifestyle attributes, demographic factors, psychographic factors, and geographic factors, in general and/or as it relates to the customer, and/or the principles regarding one or more of: proportions, complementing, context, harmony, and visual perception;
wherein said visual perception comprises one or more of: visual perception, visual attention, gestalt's principles, and visual illusions; and
(ix) avoiding inverse of the intended effects.

16. A system comprising one or more devices configured to perform operations comprising:
(a) identifying, by a computer, data, comprising one or more of: attributes, governing rules, and core rules, wherein the core rules comprise rules underlying most said rules;
(b) identifying, by the computer, relevant said data;
(c) identifying, by the computer, relative strength of said data;
(d) setting, by the computer, weights based on the relative strength of said data;
(e) joining, by the computer, relevant rule elements to formulate rules;
wherein said formulating rules comprises:
(i) identifying appropriate rule elements to join, comprising at least one of: rule elements and combinations of rule elements;
(ii) joining said rule elements to form the rules;
(iii) identifying the weights indicating extent to which at least one of the following: attributes, classes of attributes, rules, and specific combinations of rules, achieves same or similar results;
wherein results comprise at least one of the following: principle, effect, and methodology;
(iv) assigning said weights; and
(v) assessing interactions between rules, during at least one of the following events: when combined with other rules, applied to attributes, and applied to combinations of attributes; and
(f) wherein the governing rules define said interactions between at least one of: relationships, connections, inverse relationships, and inverse connections, wherein said interactions comprise at least one of the following: within rule elements, between rule elements, within rules, and between rules.

17. The system of claim 16,
(a) wherein said operations further comprise one or more of:
(i) categorizing relevant said data;
(ii) placing elements into one or more of: taxonomies and rules bases;
(iii) placing said elements comprising at least one of: attributes, rule elements, and rules, into one or more of: taxonomies and rules bases;
(iv) placing one or more of the following said elements into interface rules base: governing rules, core rules, principles, effects and methodologies rules, and formulated rules;
(v) adding the attributes into one or more of: attribute taxonomy, relevant rules, and relevant rule elements;
(vi) adding components into one or more of: principles, effects and methodologies rules, and effects and methodologies taxonomy;
(vii) wherein at least one of: taxonomies and rules bases, are utilized in conjunction with the governing rules;
(viii) wherein formulating rules further comprises at least one of the following operations:
(01) joining the relevant elements from at least one of: taxonomies and rules bases to formulate rules;
(02) repeating steps to formulate relevant inverse rules;
(03) forming relationships between one or more of: rules, specific attributes, and fully formed rules;
(04) assessing interactions to identify one or more of: conflicts and exceptions, and adjusting accordingly;
(05) assessing the attribute weights and determining adjustments required for one or more of: multiple and conflicting results, and adjusting accordingly;
(06) assessing rule accuracy, comprising at least one of: reviewing the rules for accuracy and displaying the rules for review and verification;
(07) determining adjustments required to inaccurate rules, comprising at least one of: rule and elements utilized by the rule, and adjusting accordingly; and
(08) repeating steps after adjustments are made, and adjusting accordingly;
(ix) placing verified rules into the rules bases, comprising at least one of: rules base and interface rules base;
(x) wherein the interface rules base is utilized for fully formed rules; and
(xi) wherein the governing rules are further utilized to execute one or more of the following operations:
(01) defining one or more of: inverse relationships and connections;
(02) formulating the rules;
(03) defining rule combinations, comprising which of the one or more rules combine, and how said rules interact when combined;
(04) defining rule and attributes combinations, comprising which specific one or more: rules and rules combinations, are combined with one or more specific attributes, and how said rules and said attributes interact when combined;
(05) assigning the weights;
(06) addressing subsequent relationships and connections; and
(07) addressing one or more of: multiple and conflicting results.

18. The system of claim 17,
(a) comprising one or more of:
(i) wherein the interface rules base comprises one or more of the following said elements: governing rules, core rules, principles, effects and methodologies rules, and formulated rules;
(ii) wherein the principles comprise underlying concepts for most of the rules, and consists of a relatively small number of core scientific principles and/or expert rules, comprising one or more of the following: general expert rules, domain specific expert rules, general heuristic rules, domain specific heuristic rules, general logic rules, and domain specific logic rules;
(iii) wherein the scientific principles and/or expert rules are the basis of conscious and/or unconscious expert assessment and decision-making process;
(iv) wherein formulating rules further comprises at least one of the following:
(01) joining the relevant elements from one or more of: interface rules base, taxonomies, and previously formulated rules, by applying the governing rules;
wherein said formulating rules utilizes three or more said elements from one or more said taxonomies and rules bases, and said taxonomies and rules bases comprises: attribute taxonomy and rule elements and components;
(02) identifying said elements from one or more of: interface rules base and taxonomies, and joining said elements to form core rules by applying process rules;
(03) forming relationships between one or more rules and attributes is further executed by applying core governing rules; and
(04) adjustments to inaccurate rules further comprises the rule elements and components utilized;
(v) wherein the governing rules are utilized by other said rules, and comprise one or more of: process rules, core governing rules, and application rules;
(vi) wherein the process rules comprise underlying rules that govern connections and interactions of one or more of: within taxonomies and between taxonomies, and comprise specific ways in which the taxonomy elements interact;
(vii) wherein the process rules are based on the effects and methodologies taxonomy, and form relationships between two or more of said taxonomy elements, comprising: objective, goal, parent methodology, and child methodology;
(viii) wherein the process rules are utilized by operations comprising at least one of: creating the rules and formulating core principles;
(ix) wherein said process rules are executed by connecting the elements, compromising said elements from at least one of: taxonomies and interface rules base;
(x) wherein the core governing rules perform at least one of the following:
(01) apply the rules to attributes in the attribute taxonomy, comprising at least one of: specific customer attributes and specific product attributes, to form core rules; and
(02) assign the weights indicating extent to which at least one of the following: attributes, classes of attributes, rules, and specific combinations of rules, achieves same or similar results of one or more: effect and methodology;
(xi) wherein the application rules perform at least one of the following:
(01) defining core rule combinations, comprising which of the one or more core rules combine, and how said core rules interact when combined;
(02) defining core rule and attributes combinations, comprising which specific one or more: core rules and core rules combinations, are combined with one or more of: specific customer attributes and specific product attributes, and how said rules and said attributes interact when combined; and
(03) assign the weights to the attributes to address one or more of: multiple and conflicting results;
(xii) wherein the application rules comprise customer application and/or product application governing rules;
(xiii) wherein said rule elements and components comprise at least one of: taxonomy elements and rules base elements;
(xiv) wherein the principles and the effects and methodologies rules are formed by connecting at least one of: values and classes of values, comprising at least one of the following: within taxonomies and between taxonomies; and
(xv) wherein the taxonomies comprise at least one of: attribute taxonomy, and effects and methodologies taxonomy;
(01) wherein the effects and methodologies taxonomy comprises at least one of: core effects, core methodologies, weights of elements, and weights of classes of elements;
(02) wherein the effect categories comprise at least one of: objectives, goals, and effects;
(03) wherein the methodology categories comprise at least one of: parent methodologies, child methodologies, grandchild methodologies, and specific applications;
(04) wherein the attribute taxonomy comprises at least one of the following: core attributes, values, and weights; and
(05) wherein the core attributes comprises the attributes utilized by at least one of the following: rules and values.

19. The system of claim 17,
(a) wherein said expert knowledge, comprising one or more of: explicit expert knowledge and implicit expert knowledge, is acquired and/or refined by the interface and the rules are generated with minimal human interaction, comprising at least one of the following:
(i) utilizing a body of knowledge and a framework built upon said body of knowledge;
(ii) receiving input for outstanding said rule elements and components, and incorporating input into the body of knowledge;
(iii) iterating through one or more of: relevant combinations and relevant permutations, of said rule elements and components, and automatically generating unverified rules; and
(iv) displaying rules for review in a format which mimics experts' unreflective, real-world decision making, comprising presenting view of start point and end point, for at least one of: rules and results, presenting in one or more of: focused view and collapsed view.

20. The system of claim 18,
(a) wherein said expert knowledge, comprising one or more of: explicit expert knowledge and implicit expert knowledge, is acquired and/or refined by the interface and the rules are generated with minimal human interaction, comprising at least one of the following:
(i) utilizing a body of knowledge and a framework built upon said body of knowledge;
(ii) receiving input for outstanding said rule elements and components, and incorporating input into the body of knowledge;
(iii) iterating through one or more of: relevant combinations and relevant permutations, of said rule elements and components, and automatically generating unverified rules; and
(iv) displaying rules for review in a format which mimics experts' unreflective, real-world decision making, comprising presenting view of start point and end point, for at least one of: rules and results, presenting in one or more of: focused view and collapsed view.
